(19) United States
(12) Patent Application Publication
(10) Pub. No.: US 2024/0102733 A1
(43) Pub. Date: Mar. 28, 2024

(54) SYSTEM AND METHOD FOR DRYING SLUDGE

(71) Applicant: IQ ENERGY INC., Evansburg (CA)

(72) Inventor: Darrell FORD, Evansburg (CA)

(73) Assignee: IQ ENERGY INC., Evansburg, AB (CA)

(21) Appl. No.: 18/275,973

(22) PCT Filed: Feb. 8, 2022
(86) PCT No.: PCT/CA2022/050179

§ 371 Date: Aug. 4, 2023

Related U.S. Application Data
(60) Provisional application No. 63/146,916, filed on Feb. 8, 2021.

(51) Int. Cl. F26B 25/00; F26B 3/20; F26B 17/04; F26B 17/08; F26B 21/10

(52) U.S. Cl. CPC F26B 25/002; F26B 3/20; F26B 17/04; F26B 17/08; F26B 21/10; F26B 2200/18

(57) ABSTRACT

A dryer for drying material, comprising a conveyer for conveying the material between an inlet and an outlet of the dryer, and a duct for carrying hot fluid fluidly isolated from the material. The duct extends adjacent to the conveyer from a first side of the conveyer to a second side of the conveyer opposed thereto to heat the material from both sides. A plurality of belt conveyers vertically stacked and partially horizontally staggered to sequentially convey material to be dried along a zigzag material path. A duct conveying hot fluid therein extends adjacent to the plurality of belt conveyers defining the zigzag material path to form a zigzag flow path for transferring heat to the material from above and below without contact with the material. The dryer is hermetically sealed, as are the plurality of belt conveyers from the duct.

### TECHNICAL FIELD

The disclosure relates generally to dryers for evaporating out substances from materials, particularly for drying out toxic substances from the materials.

### BACKGROUND

Drying sludge, such as sewage, industrial waste or soil laden with toxic fluids, is an important environmental and business concern, particularly with the current increased emphasis on sustainability and green technology/business practices. The current generation of dryers may involve contact of hot fluid with the material to be dried, and/or relatively costly dryer configurations. In some cases, dryers use heating oil or other liquid as a heat transfer medium. Pumping of liquids may require high power consumption. Such liquid may operate at high pressures. High-pressure and high-temperature conditions in dryers may tend to increase manufacturing and operational cost and complexity, while reducing reliability, of such dryers.

Drying sludge may require moving material dries and hardens heterogeneously, thereby causing difficulties for moving equipment and may reduce drying efficiency. Sludge may also contain solids and aggregates, which can make spreading the sludge around for effective drying, and keeping it well-exposed to heat for such purposes, a challenging task.

### SUMMARY

Leakage of industrial waste, oil spills, discharge of industrial waste into streams, and other forms of pollution have been exacting a heavy toll on the environment, plant life, wildlife, and human communities, especially marginalized or disenfranchised at-risk communities living close to pollution centres. Cost-efficient, fast, and effective remediation is critical for restoring ecosystems and improving living conditions. This is particularly true in the context of dwindling business and public expenditure (common in poorer communities), as higher costs and delays make remediation more difficulty to justify. Cost-efficient, fast, and effective dryers adapted to dry toxic materials are important components of solutions.

Soils contaminated with toxic industrial waste, including certain types of hydrocarbons, may be particularly harmful to humans. For example, such hydrocarbons may cause deleterious health effects in adults and children. Such soil may not be amenable for agriculture without first cleansing the toxic waste. Toxic waste may be removed, by evaporation or sublimation, from the material by elevating the temperature thereof.

The provision of safe, fast, energy and cost efficient, and modular/scalable dryers and methods of drying waste material is important. For example, it may be important to fluidly isolate the heating fluid from the material to be dried. Such dryers may require careful design due to large temperature variations within adjacent sections of the dryer.

Convection-based dryers pass hot fluid through the material to be dried. Such dryers may be inappropriate as the drying fluid may then carry toxic gases thereafter (e.g. VOCs). The temperature of the hot fluid may also be limited as the material to be dried may combust or be scorched if exposed to excessively hot fluid, leading to potentially dangerous situations (fire hazards). Convection drying may tend to cause the development of a boundary layer of saturated vapour at the surface of the material, which may reduce drying rates.

Non-convection-based dryers may be expensive or difficult to manufacture and may lead to heterogeneous drying, which is undesirable for safe removal of toxic waste.

Substances to be removed by drying frequently comprise multiple substances, some of which may be toxic while others may be harmless, or even beneficial. In soil contamination, water is frequently combined with a toxic substance, e.g. a hydrocarbon or a substance produced from an industrial waste spill. Water vapour and/or other non-toxic gases generated by drying may be directly used to generate power and then condensed for other purposes. Toxic substances, on the other hand, would have to be treated first. The amount of water vapour may be considerable. Costs of and time for treatment of a mixed stream of vapours may be considerably longer than a partially or fully separated stream of vapours. Separating water vapour and/or non-toxic vapours from toxic vapours in post-drying step(s) may incur a cost and time penalty, both of which may be significant.

A substantial amount of energy may be expended in drying materials. Using heating coils or certain (tuned) infrared sources to directly heat the material may reduce the amount of heat which is subsequently recoverable, e.g. to operate downstream expanders, and thus lead to large heat loss. Increasing the amount of recoverable energy may drive down the cost of operation of dryers.

For example, making effective use of heated fluids and vapours, e.g. for heating or power generation, may include separating fluids and vapours based on composition, temperature, and pressure.

Materials may tend to dry in the form of “shells”, wherein an interior portion remains at lower temperature and/or more wet, while outer portions are at relatively higher temperatures and relatively drier. Removing residual moisture from such shells may require heating of outer parts of the shell to high temperatures, and may lead to excessive energy use and heat loss.

Aspects disclosed herein provide for drying by conveying a material using an assembly of conveyer belts along a zigzag pattern and disposing a duct with hot fluid therein adjacent thereto, and fluidly isolated therefrom, to repeatedly heat the material on at least two opposed sides. Vapours generated may be discharged via venting ports. Such a configuration may facilitate separation (fractionation) of vapours, including based on toxicity; water vapour may be separated from toxic vapours. The hot fluid and the material are hermetically sealed from each other and from the atmosphere to prevent chemical reactions (combustion, oxidation, among others), leakage of toxic vapours, effective separation of evaporated substances, and reduce heat loss.

The material may be spread by using feeding the conveyer belts the material through a conduit that rotates in a reciprocating manner over an initial conveyer belt. Such rotation is substantially parallel to the initial conveyer belt, which may allow effective spreading within a relatively small space. Hard shells forming on the material may be broken up by agitating the material through the use of paddle agitators and planar vanes that float vertically in response to the material.

In one aspect, the disclosure describes a dryer for drying material, comprising: a conveyer for conveying the material between an inlet and an outlet of the dryer; and a duct for carrying hot fluid fluidly isolated from the material, the duct extending adjacent to the conveyer from a first side of the conveyer to a second side of the conveyer opposed to the first side to heat the material from the first side and the second side by transferring heat from the hot fluid.

In another aspect, the disclosure describes a method of drying material, comprising: conveying the material; and while conveying the material, flowing hot fluid isolated from, and adjacent to, the material sequentially from a first side of the material to a second side opposed to the first side to transfer heat from the hot fluid to the material.

In yet another aspect, the disclosure describes an apparatus for drying particulate moisture-bearing material, comprising: a material inlet configured to receive a continuous stream of the material for drying; a material outlet for discharging the material after drying; a plurality of belt conveyers being vertically stacked and partially horizontally staggered to sequentially convey the material vertically and horizontally in a zigzag material path from the material inlet to the material outlet, including an inlet belt conveyer for receiving the continuous stream of the material, the material being deposited substantially evenly along a width of the inlet belt conveyer; a fluid inlet for receiving fluid from a hot fluid source; a fluid outlet for discharging the fluid and fluidly connected to the fluid inlet; a duct for conveying fluid from the fluid inlet to the fluid outlet, the duct extending underneath the plurality of belt conveyers defining the zigzag material path to form a zigzag flow path to transfer heat to the material from above and below.

In a further aspect, the disclosure describes a module for a dryer, comprising: a belt conveyer for conveying material to be dried; and a duct portion disposed adjacent to the belt conveyer for conveying hot fluid fluidly isolated from the belt conveyer, the duct portion comprising one or more ports for interfacing with one or more other modules.

In another further aspect, the disclosure describes an apparatus for feeding a conveyer configured to convey material in a longitudinal direction, comprising: a conduit configured to receive material to supply the material to the conveyer via an outlet of the conduit, the conduit extending over a conveying surface of the conveyer between a pivot and the outlet of the conduit, the pivot and the outlet of the conduit being separated in the longitudinal direction; and a driver coupled to the conduit to rotate the conduit about the pivot to move the outlet at least partially laterally over the conveying surface to spread the material on the conveying surface.

In yet another further aspect, the disclosure describes a method of feeding a conveyer configured to convey material in a longitudinal direction, comprising: drawing the material predominantly parallel to, and above, a conveying surface of the conveyer; and discharging the material across the conveying surface by allowing the material to drop from above the conveying surface onto the conveying surface while rotating the material at least partially parallel to the conveying surface.

In another aspect, the disclosure describes a dryer for drying material, comprising: a conveyer for conveying the material between an inlet and an outlet of the dryer, the conveyer configured to convey the material in a longitudinal direction when receiving the material via the inlet of the dryer; a conduit configured to receive the material from the inlet of the dryer to supply the material to the conveyer via an outlet of the conduit, the conduit extending over a conveying surface of the conveyer between a pivot and the outlet of the conduit, the pivot and the outlet of the conduit being separated in the longitudinal direction; and a driver coupled to the conduit to rotate the conduit about the pivot to move the outlet of the conduit at least partially laterally over the conveying surface to spread the material on the conveying surface.

In yet further aspects, there is disclosed a computer-implemented method of controlling the dryer, comprising: sensing a sensed variable, the sensed variable being at least one of a temperature, after transferring heat from the hot fluid to the material, of at least one of the hot fluid or the material, or a pressure of the hot fluid after transferring heat from the hot fluid to the material; and controlling the mass flow rate of the hot fluid through the duct based on the sensed variable.

In various embodiments, disclosed devices and methods may facilitate drying using high temperatures, higher temperature fluids other than water, drying from multiple sides (e.g. above and below) to reduce heterogenous drying, and cost-efficient scalable dryer configurations including modular construction.

In various embodiments, devices and methods may including heating the material directly by conduction and radiation, e.g. infra-red radiation. In some cases, this may include heating the gas (e.g. air) surrounding the material. The heat transfer functions may be separated so that heat is brought into the dryer by a hot fluid that is not in flow communication with the material, and convective heating (if any) of the material is performed by the gas surrounding the material, which may be distinct from the hot fluid. For example, these two fluids may be flexibly configured separately to achieve dryer efficiency and safety standards and may permit a broader range of dryer configurations.

In various embodiments, manufacturing, maintenance, and operation costs may be reduced. In some examples, a single duct may provide heating on more than one side of the material. For example, a common pumping system may achieve the desired pressure difference, and sheet metal construction may be deployed.

In various embodiments, dryers and methods of drying may allow drying of material beyond wet grain, cellulosic products, and other materials wherein the liquid phase may be relatively less dispersed.

In various embodiments, configurations of dryers may lead to design flexibility and to account for thermal expansion, especially in the presence of large temperature gradients.

In various embodiments, dryers and methods of drying may allow indirect heating, stackable or scalable configurations, heating using flue gases or other types of gases, independently controllable heating based on retention time and dwell time (e.g. using inlet heat and conveyer speeds).

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a perspective view of a dryer, in accordance with an embodiment;

FIG. 2A is an exploded perspective view of the dryer;

FIG. 2B is an exploded side elevation view of the dryer;

FIG. 3A is a perspective view of a feeder of the dryer, showing the bottom of the feeder, in accordance with an embodiment;

FIG. 3B is a side elevation view of the feeder;

FIG. 3C is a bottom elevation view of the feeder;

FIG. 4A is a cross-sectional view of the feeder according to line 4A-4A in FIG. 3B;

FIG. 4B is a cross-sectional view of the feeder according to line 4B-4B in FIG. 3C;

FIG. 5A is a perspective view of a discharge assembly of the dryer, in accordance with an embodiment;

FIG. 5B is a top elevation view of the discharge assembly;

FIG. 6 is a cross-sectional view of the discharge assembly according to line 6-6 in FIG. 5B;

FIG. 7A is a top elevation view of a module, in accordance with an embodiment;

FIG. 7B is a side elevation view of the module;

FIG. 7C is a bottom elevation view of the module;

FIG. 8 is a cross-sectional view of the module, according to line 8-8 in FIG. 7A;

FIG. 9 is a cross-sectional view of the module according to line 9-9 in FIG. 7B;

FIG. 10 is an exploded perspective view of two assembled modules, in accordance with an embodiment;

FIG. 11 is a partial cross-sectional view of the dryer, in accordance with an embodiment;

FIG. 12 is a schematic view of a duct of the dryer, in accordance with an embodiment, wherein overlapping duct portions are shown adjacent to each other;

FIG. 13 is a partial schematic vane arrangement in a duct of the dryer, in accordance with another embodiment;

FIG. 14 is a schematic cross-sectional view of a grain dryer, as described in U.S. Pat. No. 4,253,825 to Fasano;

FIG. 15 is a side elevation view of an apparatus for drying fruit pulp, as described in U.S. Pat. No. 4,631,837 to Magoon;

FIG. 16 is a schematic cross-sectional view of an infrared wood product dryer apparatus, as described in U.S. Pat. No. 5,557,858 to Macaluso et al.;

FIG. 17 shows contours of velocity streamlines in an example module, in accordance with an embodiment;

FIG. 18 shows contours of velocity, in accordance with the embodiment of FIG. 17;

FIG. 19 shows contours of temperature, in accordance with the embodiment of FIG. 17;

FIG. 20 shows contours of velocity streamlines in an example module, in accordance with another embodiment;

FIG. 21 shows contours of velocity, in accordance with the embodiment of FIG. 20;

FIG. 22 shows contours of temperature, in accordance with the embodiment of FIG. 20;

FIG. 23 is a perspective view of a feeder of a dryer, showing the top of the feeder, in accordance with another embodiment;

FIG. 24A is a perspective view of a feed device, in accordance with an embodiment;

FIG. 24B is a side elevation view of the feed device of FIG. 24A;

FIG. 24C is a top plan view of the feed device of FIG. 24A;

FIG. 24D is a cross-sectional view of a dryer with the feed device of FIG. 24A mounted therein;

FIG. 25A is a partial cross-sectional view of a dryer, in accordance with another embodiment;

FIG. 25B is an enlarged view of region 25B in FIG. 25A;

FIG. 25C is a perspective view of the dryer of FIG. 25A, with a feeder of the dryer not shown mounted on the dryer;

FIG. 25D is a top plan view of the dryer of FIG. 25A, with the feeder and an upper module of the dryer not shown mounted on the dryer;

FIG. 27 is a flow chart of a method of drying material, in accordance with an embodiment;

FIG. 28 is a flow chart of a method of feeding a conveyer configured to convey material in a longitudinal direction, in accordance with an embodiment;

FIG. 29 illustrates a block diagram of a computing device, in accordance with an embodiment; and

FIG. 30 is a flow chart of a computer-implemented method of controlling the dryer 100.

### DETAILED DESCRIPTION

The following disclosure relates to dryers for removing moisture from wet material, particularly sludge (e.g. sewage or industrial waste) and slurries (e.g. wet drilling slurries), by promoting evaporation of moisture using heat. Heat is supplied to the dryer using hot fluid, which is fluidly isolated from material to be dried. To achieve drying, the hot fluid may be used to repeatedly heat the material from opposing sides without direct contact therewith. In some embodiments, the dryers and drying methods disclosed herein can facilitate more energy efficient, cost-effective, safer, more uniform, and quicker drying. In some cases, a modular configuration of the dryer may permit the dryer's capacity to be efficiently increased or decreased, e.g. in a scalable manner.

Aspects of various embodiments are described in relation to the figures.

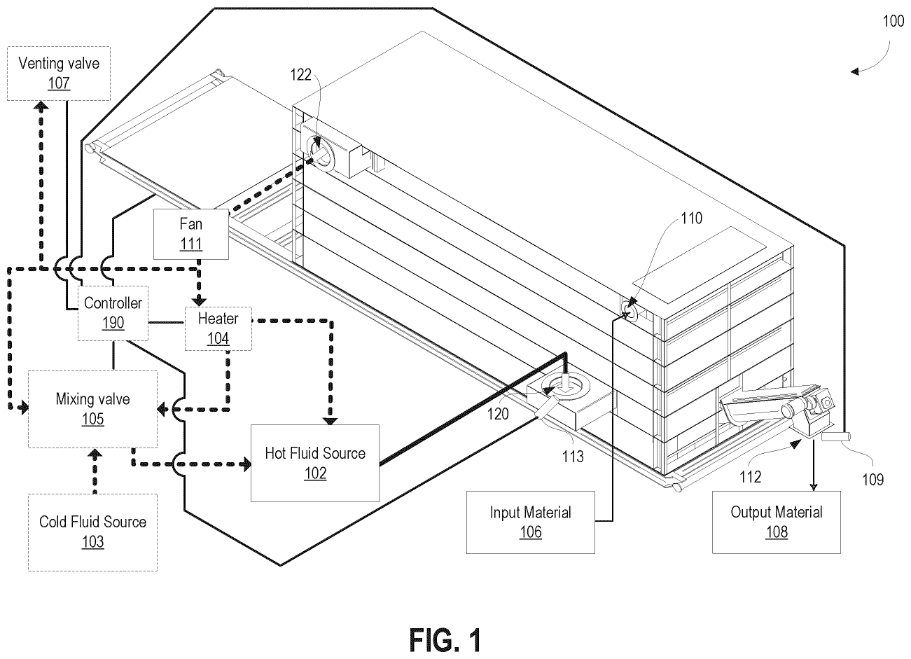

FIG. 1 is a perspective view of a dryer 100, in accordance with an embodiment, for processing material laden with moisture. In some embodiments, the dryer 100 is, or is partially or wholly part of, an apparatus for drying particulate moisture-bearing material.

Moisture may not be necessarily composed of water or water alone, e.g. moisture may be composed of liquid water and other liquids (to be dried). It is further understood that, in some cases, moisture may be at least partially frozen and thus need not strictly be in liquid form.

The dryer 100 dries the material using hot fluid. The drying may be effected without causing substantial contact between the hot fluid and the material to be dried.

In various embodiments, the hot fluid may be a gas, e.g. a flue gas or other hot gas, which may allow efficient and effective heating. For example, unlike liquids such as heating oil, gases may normally reach high temperatures without requiring commensurately high pressures. High-pressure and high-temperature, at the same time, may increase costs and reduce reliability of equipment. In many cases, industrial processes generate hot waste gases, which may be used for heating.

The material may be received by the dryer 100 as input material 106 and discharged as, generally drier, output material 108. The dryer 100 may dry the material using heat to yield the output material 108.

The input material 106 may be laden with liquid, e.g. water or other liquids, that may be dried by evaporation. For example, the input material 106 may be (partially processed or not) sewage, industrial waste, or wet soil or minerals.

Heating in the dryer 100 may encourage the moisture to at least partially evaporate or sublimate out of the input material 106 as it passes therethrough (and is transformed therein).

In some embodiments, the input material 106 may include additional liquids, which may or may not evaporate in the dryer 100. For example, the input material 106 may include a slurry of drillings submerged in lubricant and other liquids.

In various embodiments, the input material 106 may be a multiphase mixture, e.g. a suspension of particulate matter in a liquid, a colloid, or an emulsion of immiscible liquids. The dryer 100 may be particularly amenable for drying such types of materials. Drying such materials effectively may be challenging or different as compared to drying materials such wet grain, wherein the liquid or moisture to be dried is more separate or separable. In some embodiments, the dryer 100 may be adapted to the rheology of the input material 106, which may flow or resist flow depending on various factors.

The output material 108 may be at least partially dry or completely dry. In some cases, the dryer 100 may be configured to promote evaporation to remove trace concentrations of toxic moisture, which may partially or wholly compose the moisture content of the input material 106. For example, the input material 106 may be a mixture of soil and toxic liquids, and the output material 108 may be soil substantially free of the toxic liquids. Toxic liquids in soil may occur at relatively low or minute concentrations. If little other moisture is present, the input material 106 may then appear relatively dry.

A material inlet 110 of the dryer 100 may be configured to receive a continuous stream of the input material 106.

A material outlet 112 may discharge the material after drying.

The material inlet 110 and material outlet 112 may be configured to draw material in and out, respectively, without drawing in, or releasing, additional vapour and/or gases. For example, the material inlet 110 and material outlet 112 each may comprise a sealing or airlock mechanism. In some embodiments, a knife-gate valve may be used when the material is relatively less flowable, e.g. contaminated soil. In some embodiments, the provision of systems to reduce or stop entry of air into portions of the dryer 100 carrying the material may be important to mitigate undesirable or harmful oxidation of the material and dilution of vapours generated by drying the material in the dryer 100.

In some embodiments, an extrusion system may be used for drawing in material via the material inlet 110. Extrusion may fill the material inlet 110 in a manner to avoid or mitigate other mass flow into or out of the dryer 100 via the material inlet 110, e.g. outside air entering the dryer 100 or toxic air from inside the dryer 100 escaping outside.

In some embodiments, control of vapour/air flow into and out of the dryer 100 may reduce combustion hazards. In some embodiments, vapours generated in the sealed dryer 100 may be drawn off (vented) to be then used for other purposes. In some cases, vented vapours may be to regenerate energy. In some cases, reducing dilution of vapours may facilitate such uses. In some embodiments, reducing dilution may avoid heat loss, which may allow vented gas to be more efficiently used for heating and/or generating power, e.g. using a low-temperature cycle (low temperature organic rankine cycle). For such example reasons, in some embodiments, additional insulation (e.g. “180”) or cladding may be used to reduce heat loss from the dryer 100.

A fluid inlet 120 of the dryer 100 may receive fluid from a hot fluid source 102 in the form of hot fluid. The dryer 100 transfers heat from this fluid to the material, to promote drying.

A fluid outlet 122 of the dryer 100 may discharge the fluid out of the dryer 100 in the form of fluid that is less hot (warm fluid, or relatively cooler fluid).

The fluid outlet 122 may be fluidly connected to the fluid inlet 120, e.g. via duct extending therebetween.

The fluid inlet 120 and the fluid outlet 122 may, respectively, draw fluid into the dryer 100 or discharge fluid out of the dryer 100 via airlocks, knife-gate valves, or other valves configured to prevent the outside air from entering the dryer 100 and fluid from inside the dryer 100 escaping outside the dryer 100, via the fluid inlet 120 and the fluid outlet 122.

Additional venting outlets may be provided in the dryer 100 to release gases and vapours, e.g. evaporating from the material. In various embodiments, additional venting outlets may be distributed along the drying path to draw out vapour closer to where it is generated.

The dryer 100 may be otherwise hermetically sealed and may not allow passage of fluid and material in or out except via the material inlet 110, the material outlet 112, the fluid inlet 120, fluid outlet 122, and any additional venting outlets.

The dryer 100 may be adapted to operate in a countercurrent configuration with respect to the flow of the fluid and the movement of the material between the material inlet 110 and the material outlet 112. As the fluid flows between the fluid inlet 120 and fluid outlet 122, it may transfer heat to material proximal to the material outlet 112 before material distal thereto, i.e. proximal to the material inlet 110. Fluid exiting the fluid outlet 122 of the dryer 100 may be generated by cooling of the hot fluid that enters the dryer 100 via the fluid inlet 120.

The countercurrent configuration may facilitate more effective drying by increasing local heat transfer to the material where it is relatively drier or warmer. For example, such a configuration may be useful when drying rate, expressed as rate of evaporation or sublimation, depends significantly on local moisture content of the material and ambient conditions within the dryer, including local (partial) vapour pressure and temperature.

In some embodiments, the dryer 100 may be adapted to operate in a co-current configuration. For example, such a configuration may include reversing the flow of (hot) fluid through the dryer 100 from the fluid outlet 122 to the fluid inlet 120.

In some embodiments, the hot fluid source 102 may include hot fluid maintained at a temperature to achieve desired drying in the dryer 100.

In some embodiments, a heater 104 may generate hot fluid to heat and supply to the hot fluid source 102. In some embodiments, the hot fluid source 102 may include fluid heated by or carrying waste heat from an industrial process or energy generation plant. In some embodiments, the heater 104 and/or the hot fluid source 102 may include a combustor or a gasification system such as a pyrolysis system, e.g. a pyrolysis system for breaking down dried organic matter generated by the dryer 100. The pyrolysis system may generate gases used in a combustor. In various embodiments, the heater 104 may be configured to heat fluid received from the dryer 100 via the fluid outlet 122 to heat the fluid to generate the hot fluid for recirculation through dryer 100 via the fluid inlet 120.

In some embodiments, the temperature of fluid entering the dryer 100 may be controlled by using a mixing valve 105. The mixing valve 105 may mix hot fluid from the heater 104 with cold fluid from a cold fluid source 103 to generate temperature-controlled fluid for supplying to the dryer 100. For example, the mixing valve 105 may be a flow divider valve.

In various embodiments, the mixing valve 105 may be configured to receive fluid from the dryer 100 via the fluid outlet 122 to mix the fluid with another hot fluid to generate the hot fluid for recirculation through the dryer 100 via the fluid inlet 120.

In some embodiments, the dryer 100 may be configured in a supply-return configuration, wherein the fluid supplied to the dryer 100 flows in a partial closed-loop. The fluid inlet 120 may be a supply passage and the fluid outlet 122 may be a return passage. For example, returning fluid may be, at least partially, (re-)heated and (re-)supplied back to the dryer 100 as supply flow. In some embodiments, the mixing valve 105 may at least partially mix the returning, cooler fluid with hotter fluid from the heater 104, and possibly other flow streams, to achieve a target fluid temperature for the supply flow. Reheating and then recirculation of hot fluid back into the dryer 100 after exit from the fluid outlet 122 may increase efficiency of the dryer 100.

In some embodiments, a venting valve 107 may be provided to vent fluid after it exits from the fluid outlet 122. Venting may be used to control the mass and/or temperature of the hot fluid in the dryer.

In various embodiments, a fan 111 may be used to increase or maintain a mass flow rate of the hot fluid flowing through the fluid inlet 120 and/or to increase or maintain the pressure at the fluid inlet 120. Maintaining a mass flow rate or pressure may include holding the mass flow rate or the pressure, respectively, at a fixed constant value. In some embodiments, the fan 111 may be an induced draft fan.

In some embodiments, the temperature of fluid in the hot fluid source 102 may be controlled via a controller 190, e.g. a programmable logic controller (PLC). The controller 190 may include a computing device having one or more processor(s) coupled to machine readable non-transitory memory having instructions stored thereon to cause the one or more processor(s) to execute a method. For example, such a method, when executed, may cause the temperature of hot fluid entering the dryer 100 to change, or may change the rate of transport of material through the dryer 100 to influence the dryness of the output material 108.

The controller 190 may be coupled to sensors, valves, and other components. In various embodiments, the controller may be connected to, and control, the heater 104, the mixing valve 105, and the dryer 100 itself, including conveyer motors therein. The controller 190 may control such components based on setpoints and/or sensors, including temperature sensors disposed inside the dryer 100. In some embodiments, the controller 190 may be configured to control the temperature of the hot fluid flowing through the fluid inlet 120 using the fan 111.

In some embodiments, a sensor 109 may be provided at the material outlet 112 to determine a quality of the material after processing. In some embodiments, the sensor 109 may be configured to measure (or sense) temperature of the material. For example, a target temperature for material at the outlet 112 may be 300° F. or more to ensure adequate drying and sterilization. For example, such temperatures may be measured and logged in a data repository to facilitate verifiable sterilization of organic material in sewage. In some embodiments, the controller 190 may control the heater 104, the fan 111, and/or the mixing valve 105 based on measurements from sensor 109 to achieve a target temperature and/or dryness.

In some embodiments, a sensor 113 may be provided at the fluid inlet 120 to measure (or sense) a temperature or pressure of the hot fluid as it enters the dryer 100. In some embodiments, the controller 190 may control the heater 104, the fan 111, and/or the mixing valve 105 based on measurements from sensor 111 to achieve a target temperature and/or pressure of the hot fluid, e.g. at the fluid inlet 120.

In some embodiments, the controller 190 may be configured to control a mass flow rate of the hot fluid through the dryer 100 based on a temperature, (measured) after transferring heat from the hot fluid to the material, of at least one of the hot fluid (sensed through a temperature probe) or the material (measured using the probe 109).

The hot fluid may be gas or liquid. For example, the gas may be air. The temperature of the hot fluid may be up to 1000° F. or more. It is understood that although the temperature of the fluid may be 1000° F., the temperature of the material may be considerably less.

Material flow may be indicated using arrows with unfilled arrowheads, while fluid flow may be indicated with block arrows and/or arrows with filled arrow heads.

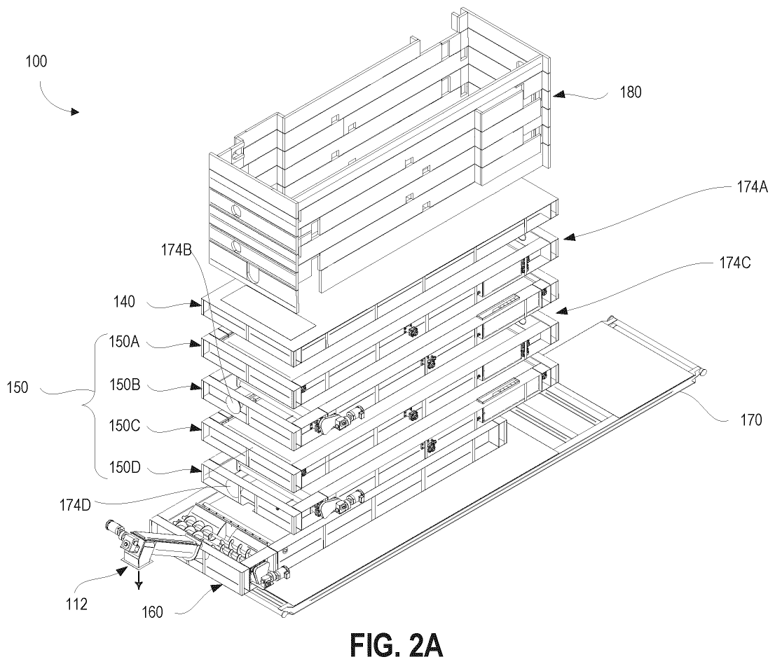

FIG. 2A is an exploded perspective view of the dryer 100.

FIG. 2B is an exploded side elevation view of the dryer 100.

In generally sequential order with respect to material flow, the dryer 100 may comprise a feeder 140 receiving the material into the dryer via the material inlet 110, a plurality of modules 150 that may be daisy-chained to facilitate drying of the material, a discharge conveyer 160 for carrying processed material from the plurality of modules 150 out of the dryer 100 via the material outlet 112, and a plate 170 (or skid) disposed underneath the discharge conveyer 160.

A housing 180 attached, or otherwise anchored, to the plate 170 may house the feeder 140, plurality of modules 150, and the discharge conveyer 160. In some embodiments, the housing 180 may partially encase or sheath such components to maintain structural integrity of the dryer 100, and provide well-defined ports, e.g. input/output ports for operators.

The dryer 100 may be configured to compensate for material expansion due to temperature gradients across the dryer 100. For example, modules may be fastened to each other by means of fasteners engaging in slots rather than narrow tolerance holes. Modularity may facilitate compensation for such material expansion.

The plurality of modules 150 may include modules 150A, 150B, 150C, 150D, which may be mutually complementary. In some embodiments, the modules 150A, 150B, 150C may be substantially identical to each other. As shown in FIG. 1 and FIG. 2A, the module 150D may be modified (relative to the remaining modules) to accommodate a port for the fluid inlet 120 and may otherwise be identical to the modules 150A, 150B, 150C.

In some embodiments, the dryer 100 may be modular. For example, drying capacity may be varied by adding or removing modules between the feeder 140 and the module 105D coupled to the discharger conveyer 160. In some cases, the housing 180 may be removable, replaceable, or otherwise adaptable to a varying number of installed modules.

When the feeder 140 and the modules 150A, 150B, 150C, 150D (or one or more thereof) are sequentially connected, such as by coupling to each other, they may form a conveyer (or heated conveyer) coupling with the discharge conveyer 160.

Each of the plurality of modules 150 may define a respective duct portion. The feeder 140 may also define a respective duct portion. In the conveyer, the plurality of duct portions so defined may fluidly couple to each other in sequence to form a (single) substantially continuous duct for carrying hot fluid and extending from the fluid inlet 120 to the fluid outlet 122.

The plurality of modules 150 may each have a respective belt conveyer. In the conveyer, the plurality of belt conveyers may be arranged for substantially continuously conveying the material received from the feeder 140 to the discharge conveyer 160.

The conveyer transports material supplied by the feeder 140 along a substantially continuous material path, concurrently drying the material using hot fluid flowing along a substantially continuous flow path adjacent to and fluidly isolated from the material flow path, and thereafter releases the material via the discharge conveyer 160.

The various components and aspects of the dryer 100 that may facilitate drying of material are now described in detail, with reference to the figures.

Each module 150A, 150B, 150C, 150D may include a corresponding venting port 174A, 174B, 174C, 174D for venting evaporated liquids from the dryer 100.

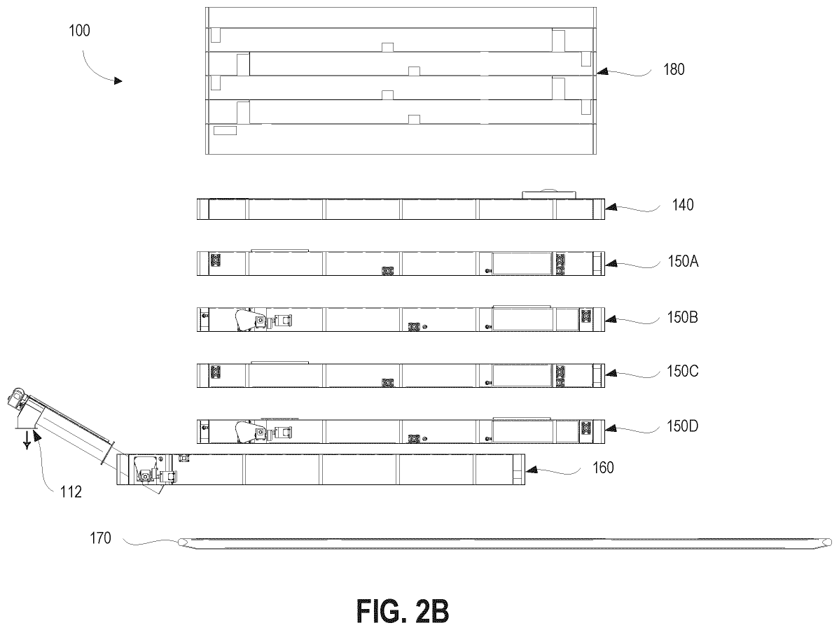

FIG. 3A is a perspective view of the feeder 140, showing the bottom of the feeder 140, in accordance with an embodiment.

FIG. 3B is a side elevation view of the feeder 140.

FIG. 3C is a bottom elevation view of the feeder 140.

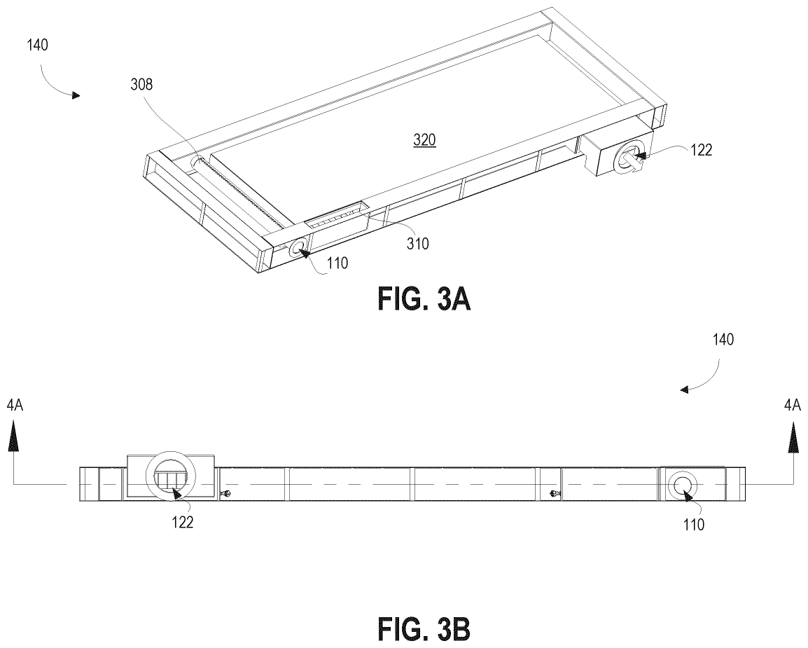

FIG. 4A is a cross-sectional view of the feeder 140 according to line 4A-4A in FIG. 3B.

FIG. 4B is a cross-sectional view of the feeder 140 according to line 4B-4B in FIG. 3C.

A partial perspective view of the feeder 140, showing the top of the feeder 140 is included in the exploded perspective view of FIG. 2A. In this case top/bottom are meant in reference to gravity and/or the general direction of material flow, which is brought from a higher location to a lower location at least partially with the aid of gravity.

A continuous stream of material for drying is fed to the feeder 140 via the material inlet 110. For example, in some embodiments, the material may be rheologically suited for “flowing” and may thus be supplied as a continuous flow of semi-solid material.

The material so received may be deposited continuously by the feeder 140 on an inlet conveyer belt. The material may be deposited substantially evenly along a width of the inlet belt conveyer. The inlet conveyer belt may form part of the module 150A (not shown in FIGS. 3A-3C and FIG. 4A-4B) and may be configured for receiving such a continuous stream of the material.

As referred to herein, “belt” may include interlocking chain belts, woven stainless steel belts, or other types of belts. In various embodiments, belts may be configured to translate material placed thereon by moving in a longitudinal direction by engagement (e.g. frictional engagement) with roller(s) and/or wheel(s) rotating in a lateral direction. For example, a belt may extend longitudinally between two rollers or wheels.

The material received from the material inlet 110 may be supplied to a feed tube 308. The feed tube 308 may be in flow communication with the material inlet 110 to receive material is fed into the feeder 140 as a flow.

In some embodiments, the feed tube 308 may extend across an internal width 312 of the feeder 140, which may be substantially commensurate with and disposed above the width of the inlet conveyer belt. The feed tube 308 may deposit the material substantially across the width of the inlet conveyer belt.

In some embodiments, a plurality of holes may be distributed along the width of the feed tube 308, on a circumferential end of the feed tube 308 facing the inlet conveyer belt, to allow passage of material therethrough onto the inlet conveyer belt.

In various embodiments, the distribution of holes may be adapted to provide a substantially even heating of the material, e.g. spacing between holes may be small and locations corresponding to areas where heating might be less may not have holes.

In some embodiments, the material flowing through the material inlet 110 may be sufficiently flowable and extrudable. The plurality of holes may function as extrusion holes, e.g. circular extrusion holes. Such extrusion may encourage material to substantially fill the feed tube 308. Extrusion may discourage or prevent air inclusions or vapour exchange between the dryer 100 and the environment outside the dryer 100. An extrusion configuration may facilitate forming a substantial seal or airlock to prevent vapour exchange.

For example, a pattern of continuous cylindrical deposit of material may be formed on the inlet conveyer belt. The extrusion patterns may be adapted to substantially cover a surface of the belt conveyer.

As seen in FIG. 4A, a duct portion 410 of the feeder 140 is defined between two openings defined by, respectively, the fluid outlet 122 and a feeder port 310.

The feeder port 310 is configured to couple with the module 150A to establish flow communication between duct portions of the feeder 140 and the module 150A.

Hot fluid may be received via module 150A, pass through the duct portion 410 of feeder 140, and then be discharged via the fluid outlet 122. The flow of hot fluid in the duct portion 410 heats a feeder surface 320 of the feeder 140, which in turn heats the material on the inlet belt conveyer without contact. The feeder 140 may provide one-sided heating via the feeder surface 320 from above the material deposited on the inlet conveyer belt.

The internal width 312 and an internal length 314 of the feeder 140 may be adapted to the dimensions of the inlet conveyer belt.

The fluid outlet 122 and the feeder port 310 may be disposed at opposed longitudinal ends of (an internal portion of) the feeder 140.

In the context of the feeder 140, “lateral” may refer to alignment with the internal width 312, and “longitudinal” or “longitudinal direction” may refer at least to alignment with an internal length 314 of the feeder 140.

The two openings may define therebetween flow paths for (hot) fluid to flow through the feeder 140, across the internal width 312 and/or the internal length 314. The duct portion 410 may accordingly extend substantially along the internal width 312 and/or internal length 314 of the feeder 140, and above the inlet conveyer belt.

The duct portion 410 defined by the feeder 140 may include feeder vanes 464 to direct flow inside the duct portion from the feeder port 310 to the fluid outlet 122. The feeder vanes 464 may be configured to ensure flow is distributed across the duct portion 410, i.e. across the internal width 312 and the internal length 314, by defining a plurality of adjacent channels in the duct portion 410. In some embodiments, the feeder vanes 464 form a plurality of adjacent channels inside the duct portion 410, and which also run along the internal width 312 and the internal length 314.

As shown in FIG. 4A, in some embodiments, the feeder vanes 464 extend (in the direction of the flow) along the duct portion in a “U-shape” so that the fluid at the fluid outlet 122 is flowing out in a direction substantially opposite to the fluid flow at the feeder port 310.

It is found that efficient heating via the feeder 140 and efficient pumping of hot fluid therethrough may be achievable by a configuration of the feeder vanes 464. For example, in some embodiments, ten vanes may be provided to define channels therebetween. In some embodiments, the feeder vanes 464 may be equally spaced in parallel or “straight” sections. In some embodiments, the minimum and maximum curvature of the feeder vanes 464 may be kept within a range. In some embodiments, curved sections in the feeder vanes 464 may be substantially similar, or may be configured to mitigate generation of turbulence.

The feeder 140 may be covered from the top and may include a removable window for accessing the feed tube 308, and other components proximal thereto.

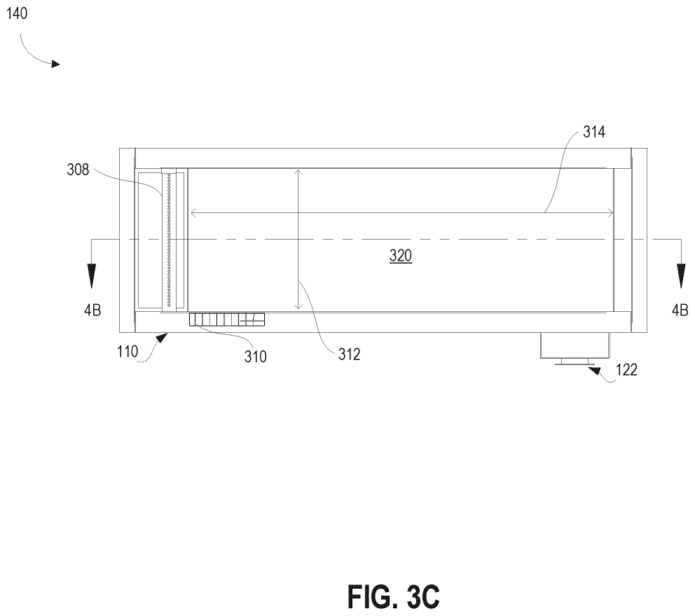

FIG. 5A is a perspective view of a discharge assembly 500 of the dryer 100, in accordance with an embodiment.

FIG. 5B is a top elevation view of the discharge assembly 500.

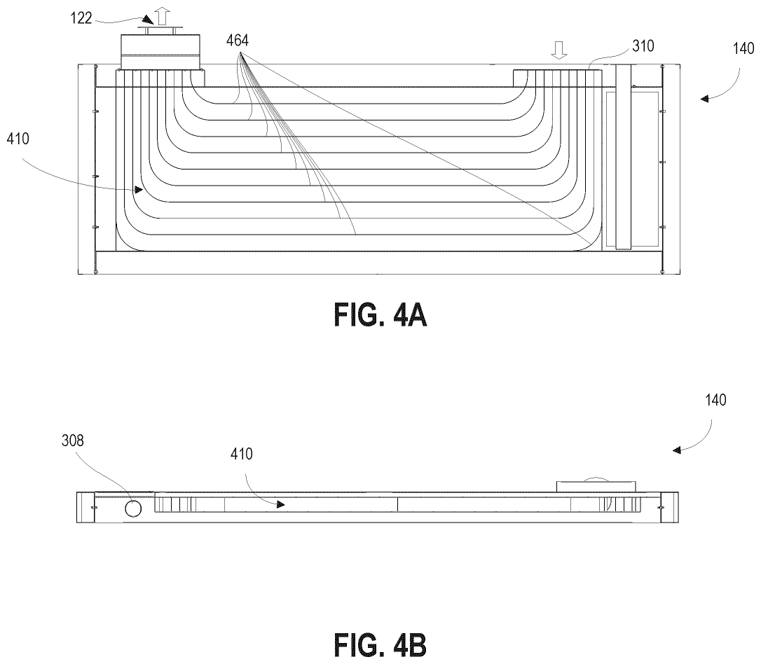

FIG. 6 is a cross-sectional view of the discharge assembly 500 according to line 6-6 in FIG. 5B.

The discharge assembly 500 may be configured to receive material from the module 150D and discharge it out of the material outlet 112.

The discharge assembly 500 may comprise the discharge conveyer 160 and the plate 170 whereupon it is mounted.

The discharge conveyer 160 may include lateral worm conveyers 520A spaced apart from lateral worm conveyers 520B to form a central opening 522 defined therebetween. An inclined conveyer 524, which may also be a worm (or screw) conveyer, may be at least partially disposed in the central opening 522. The inclined conveyer 524 may include covering plates to maintain a hermetic seal to prevent vapours from escaping the dryer 100.

In some embodiments, one or more worm conveyers may act as augers to break up and mix the (dried) material.

Material from the belt conveyer of the module 150D may fall on to the lateral worm conveyers 520A, 520B. The lateral worm conveyers 520A, 520B may be configured to rotate to convey material towards the central opening 522. The material may move towards and fall onto the inclined conveyer 524 via the central opening 522. The inclined worm conveyer 524 may then convey material upwardly and out of the dryer 100 via the material outlet 112.

A collector 530 or catch may be formed underneath the belt conveyer of the module 150D, e.g. using the discharge conveyer 160 and plate 170 in combination, and may be configured to catch material not fallen into the lateral worm conveyers 520A, 520B. The inclined conveyer 524 may open to the collector 530 to draw material in the collector 530 out of the dryer 100. Brushes on the module 150D may facilitate catching of material leftover on its belt conveyer.

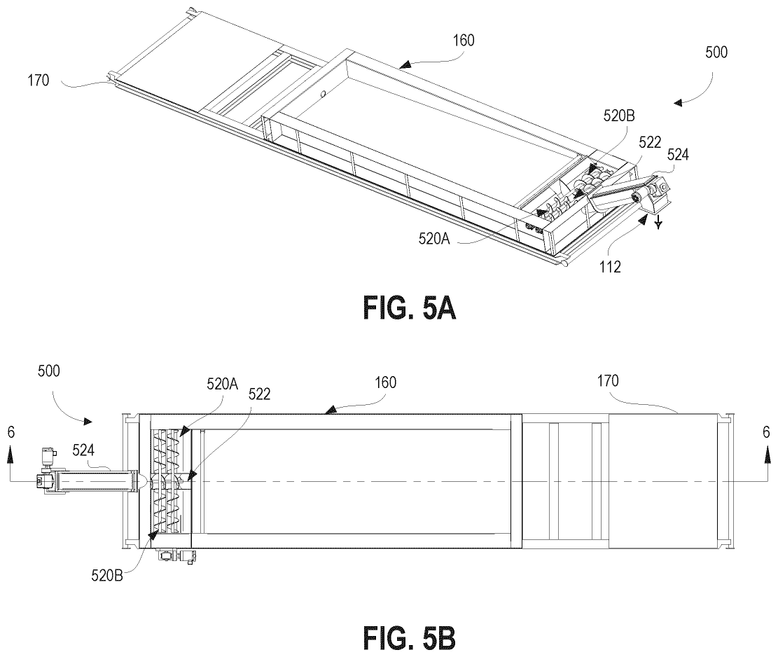

FIG. 7A is a top elevation view of the module 150A.

FIG. 7B is a side elevation view of the module 150A.

FIG. 7C is a bottom elevation view of the module 150A.

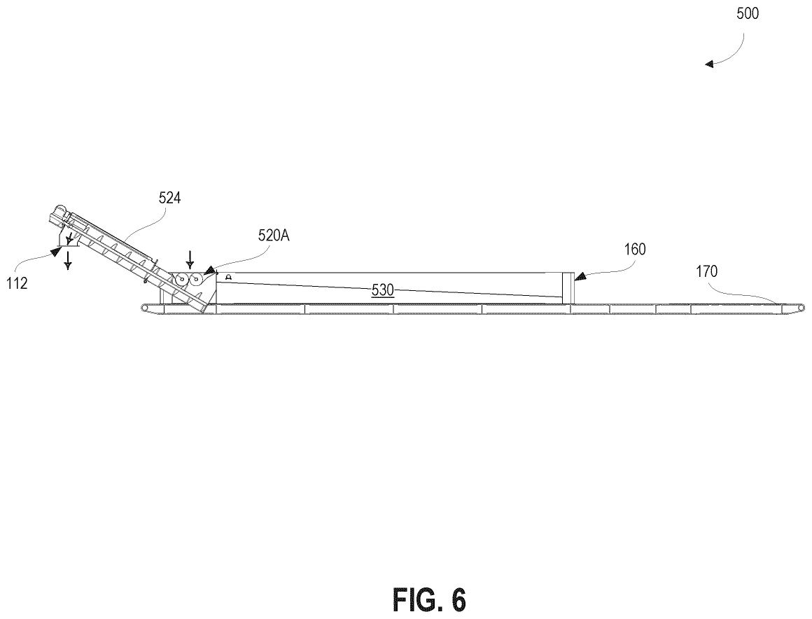

FIGS. 7A-7C (and FIG. 8 shown later) may be representative, as the modules 150A, 150B, 150C, 150D may be substantially similar.

A belt conveyer 750 of the module 150A conveys the material along a length 714 of the belt conveyer 750 until it reaches a gap 718 formed in the module 150A. The material falls off the belt conveyer 750 through the gap 718 on to the next belt conveyer, here associated with the module 150B.

In various embodiments, the belt conveyer 750 may be substantially non-porous or may be disposed over (on the upper part of the module 150A) or under (on the lower part of the module 150A) a non-porous surface, so that the hot fluid is fluidly isolated from the material placed on the belt conveyer 750. For example, the non-porous surface may comprise (solid) sheet metal.

The belt conveyer 750 may be offset (from center) with respect to an outer frame of the module 150A so that there is substantially no gap at a longitudinal end opposed the gap 718, which itself is formed at a longitudinal end.

A brush 728 of the module 150A may be disposed underneath the belt conveyer 750 to remove or brush off residual material from the belt conveyer 750 on to the next belt conveyer. For example, the brush 728 may extend along a width 712 of the belt conveyer 750 to remove as much residual material as possible. In some embodiments, the material may be outwardly dried and/or caked at the end of the belt conveyer proximal to the gap 718. The brush 728 may break up the dried and/or caked material before it falls on the next belt conveyer. In some cases, the brush 728 may facilitate exposing wet (or insufficiently dried) portions of the material.

The module 150A may be an inlet module, disposed adjacent to the feeder 140. The belt conveyer 750 of the module 150A may be the inlet belt conveyer receiving material from the feed tube 308.

Each of the modules 150A, 150B, 150C, 150D has an associated belt conveyer 750. Altogether, these form a plurality of belt conveyers at least partially defining a conveyer conveying the material from top to bottom through the dryer 100.

A first port 710A and a second port 710B of the module 150A may define openings for a duct portion of the module 150A. The first port 710A and the second 710B may be on opposed lateral and longitudinal sides of the module 150A. The first port 710A may open on the top side of the module 150A, while the second port may open on the bottom side of the module 150A. The openings defined by the first port 710A may be spaced apart from the opening defined by the second port 710B by a height 716 (or thickness) of the module 150A, lateral to the belt conveyer 750.

The first port 710A and second port 710B may define opposed ends of the duct portion. The duct portion may extend along the width 712 and length 714 of the belt conveyer 750, the height 716 of the module 150A, and underneath the belt conveyer 750.

Sensor probes 720A, 720B may be provided in the duct portion, proximal to, respectively, the first port 710A and the second port 710B, to measure flow temperature, pressure, velocity, and other characteristics of the fluid in the duct. Similarly a sensor probe 721 may be provided in the gap 718 to measure conditions material being conveyed in the module is exposed to, e.g. temperature, pressure, and humidity. For example, such measurements (from some or all of the sensor probes) may be used by the controller 190 to control drying of the material in the dryer 100.

In the context of the belt conveyer 750 of the module 150A, “lateral” may refer to alignment with the width 712, and “longitudinal” or “longitudinal direction” may refer to at least to alignment with the length 714. The length 714 may be parallel to the direction of travel or conveyance of material on the belt conveyer 750. For example, a longitudinal direction 715 may aligned with length 714 and may be associated with a direction of motion of the material on the belt conveyer 750. The width 712 may be perpendicular or lateral to the length 714.

Panels 760 may close or seal side openings adjacent to the ports. The duct portion of the module 150D may have such a panel 760 only at one end, the inlet end. The panels 760 may act as flow diverters to direct the flow into the respective module (at the inlet of the duct portion) and into the adjacent module (at the outlet of the duct portion), while preventing leakage. The panels 760 may be removable to facilitate connecting the duct to a (e.g. external) flow component, conduit, or source. For example, the duct portion of the module 150D may have an end with a panel removed to accommodate a port for the fluid inlet 120.

Upper and lower sides of the belt conveyer 750 may be heat transfer surfaces, e.g. these may be heated by hot fluid flowing through the module 150A, and may thus heat the material being conveyed on the (upper side) of the belt conveyer 750, from multiple sides.

FIG. 8 is a cross-sectional view of the module 150A according to line 8-8 in FIG. 7A.

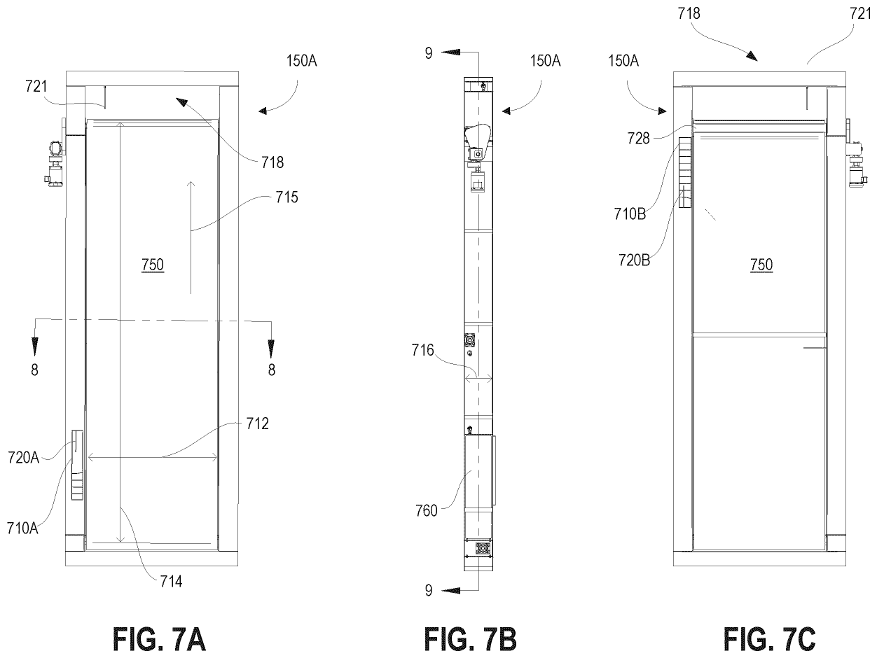

FIG. 9 is a cross-sectional view of the module 150A according to line 9-9 in FIG. 7B.

The module 150A defines a duct portion 820 therein extending between the first port 710A and the second port 710B.

The duct portion 820 may be portion of a substantially continuous duct in the dryer 100. The duct may comprise a plurality of channels formed therein, in some or all the duct portions thereof.

The duct portion 820 may extend substantially fully underneath the belt conveyer 750 to provide a full or larger area for heat transfer to the material on the belt conveyer 750 from the hot fluid flowing through the duct portion 820 (see short-headed arrows) to the material on the conveyer belt 750. In various embodiments, the duct portion 820 may have planar portions to convey heat transfer corresponding to planar portions of a conveying surface of the belt conveyer 750.

The duct portion 820 may comprise a plurality of vanes 964 defining channels 830 in the duct portion 820. In some embodiments, the channels 830 may be adjacent to one another. In some embodiments, the channels 830 are substantially or at least partially parallel to one another. Such channels may be formed using vanes or guiding surfaces. The channels may be substantially 5-shaped from the first port 710A to the second port 710B, and may define a substantially straight portion intermediate between the first port 710A and the second port 710B.

In some embodiments, the feeder 140 may have also similar vane arrangement.

The channels 830 may ensure that the hot fluid does not flow from one port to another in a localized manner (e.g. avoiding the edges of the duct portion 820), since this may reduce heat transfer or cause uneven heat transfer.

In various embodiments, it is found that the vane arrangement may be particularly suitable to achieve heat transfer to the material via the belt conveyer 750. In some embodiments, channel width (e.g. lateral width), the number of channels, and curvature of vanes 964 defining the channels 830, are particularly suitable for efficient heat transfer and flow through the duct portion 820.

One or more rollers may be provided to move the belt of the module 150A forward, e.g. an intermediate roller 932 and a downstream roller pair 934 comprising a roller for the belt and a brush roller for the brush 728. An upstream roller 936 may disposed vertically above the intermediate roller 932. The rollers may be operably via adapters 938 configured to couple with power inputs.

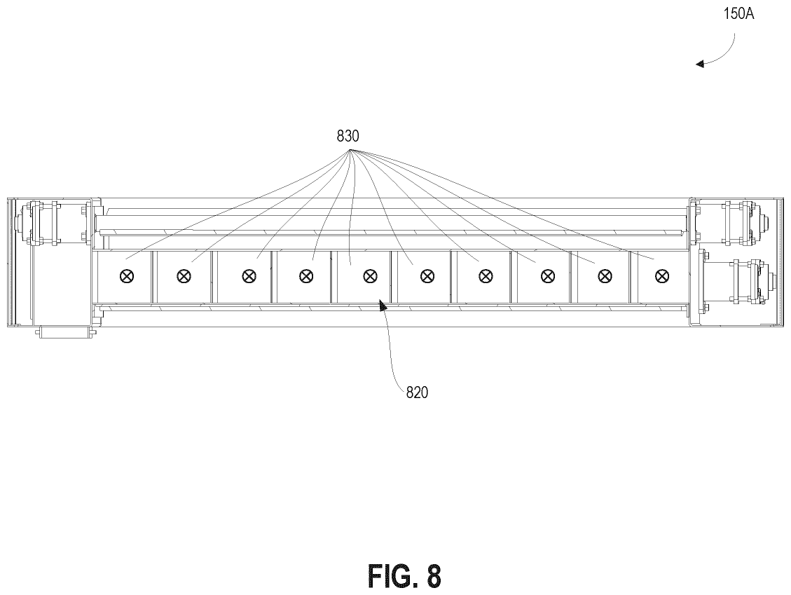

FIG. 10 is an exploded perspective view of the module 150A assembled with the module 150B, in accordance with an embodiment.

The pair of modules in FIG. 10 may be representative, as the plurality of modules 150 may be identical and arranged adjacent to each other. For example, a configuration of two adjacent upper and lower modules may be substantially like those of module 150A and module 150B, respectively.

The module 150A is arranged over the module 150B in a reversed configuration. The module 150B is rotated 180° about each of the lateral and longitudinal directions, relative to module 150A.

The first port 710A of the module 150B may be adjacent to the second port 710B of the module 150A, and in flow communication therewith to form a substantially contiguous section of the duct through which hot fluid flows. The duct portions of module 150A and 150B may be in flow communication and connected via the first port 710A of the module 150B and the second port 710B of the module 150A.

In some embodiments, vanes in the module 150A may not be contiguous with vanes in the module 150B. In some embodiments, fluid in the vanes may not be separated in-between the duct portions of the module 150A and module 150B.

Hot fluid may flow through (the duct portions of) module 150A and module 150B in opposed or alternating (longitudinal) directions.

Similarly, material may be conveyed via (the belt conveyers of) module 150A and module 150B in opposed or alternating (longitudinal) directions.

Any two adjacent modules, such as module 150A and module 150B, form upper and lower modules with respect to the material being conveyed therebetween. The upper and lower module together heat the material (transferring heat thereto), respectively, from above and below.

Additional vertical heating may be provided to the material as the hot fluid flows from one module to another, e.g. through the ports of modules 150A, 150B that are adjacent to each other (via a plane opposed the panels 760).

A vertical space between the upper module and the belt conveyer of the lower module may define an upper limit for the thickness of the material on the lower module's belt conveyer. In various embodiments, the vertical space may be sufficiently narrow to ensure substantial heating of the material from both top and bottom, and to limit heterogenous heating and drying across the thickness of the material. In some embodiments, the vertical space may be configured to ensure substantially similar or identical heating from both sides, e.g. the material may be centred approximately midway between heating surfaces of the upper and lower modules.

The material in module 150A may be sandwiched between the duct portion of the module 150A and the feeder 140, which provides one-sided heating (unlike the plurality of modules 150), and thus may be also heated in a similar manner to the material between adjacent modules.

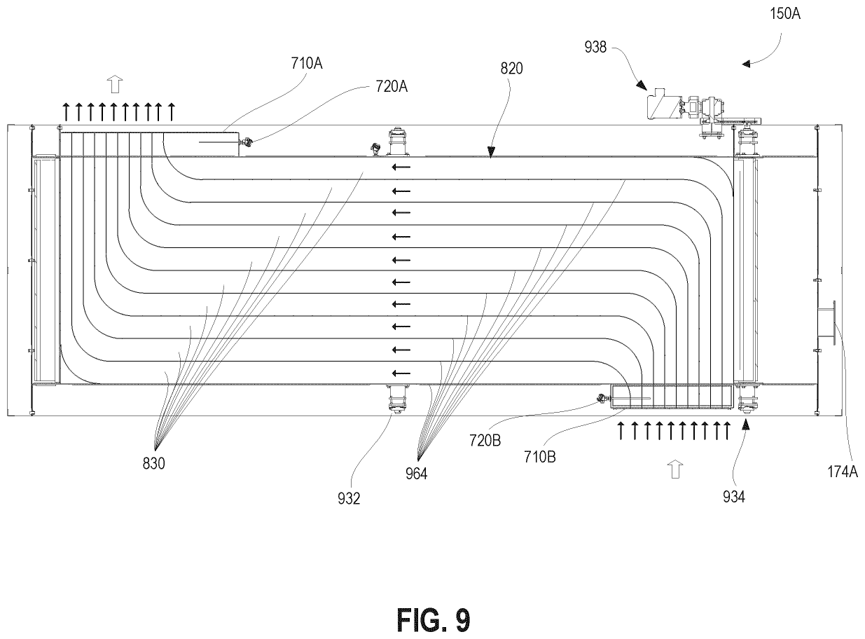

FIG. 11 is a partial cross-sectional view of the dryer 100, in accordance with an embodiment.

The modules 150A, 150B, 150C, 150D together form a plurality of belt conveyers 1100 comprising belt conveyers 750 of the modules 150A, 150B, 150C, 150D. The conveyer conveys the material between the material inlet 110 (where the material is laden with moisture) and the material outlet 112 of the dryer 100. The plurality of modules 150 may be interfaced to form a plurality of belt conveyers 1100 conveying the material along a zigzagging material path 1120.

The plurality of belt conveyers 1100 are vertically spaced apart, partially horizontally (or longitudinally) staggered, and have overlapping sections defined between the gaps 718. The plurality of belt conveyers 1100 partially extend over each other to sequentially convey the material, vertically and horizontally, in a zigzag material path 1120 from the material inlet 110 to the material outlet 112. The material path 1120 may comprise sections that overlay other sections.

Venting port 174A, 174B are disposed adjacent to the respective gaps 718 to discharge vapours generated by the drying process. Such vented ports may facilitate local and relatively immediate venting of vapours from the, otherwise sealed, dryer 100. In some embodiments, venting ports 174A, 174B may discharge vapours along fluidly separated paths. In some embodiments, the discharged vapours from different venting ports may be treated differently and be kept separate. For example, in some embodiments, vapours from some venting ports may be exhausted to the atmosphere whereas vapours from other venting ports may be further processed.

The venting may be used to draw off vapours in specific temperature ranges, as vapour temperature proximal to different modules may be significantly different. The vapours so discharged may be used for heating and power generation based on the vapour's thermodynamic state, e.g. enthalpy and/or free energy.

In some embodiments, moisture comprises a combination of substances with different evaporation points. The venting ports 174A, 174B, 174C, 174D and the zigzag material path 1120 may be configured to fractionate or separate the substances, based on vaporization temperature and pressure. Venting port 174A may discharge vapour streams comprising relatively more substances with a relatively lower boiling temperature (vapour pressure), and the venting port 174B may discharge vapour stream comprising relatively more substances with a relatively higher boiling temperature (vapour pressure). In some embodiments, the vented vapours may be so separated based on toxicity, since this may be correlated with boiling temperature, and thus the venting ports 174A, 174B, 174C, 174D may facilitate processing of toxic vapours. In some embodiments, primarily non-toxic vapours may be discharged from the venting ports 174A, 174B and thus may be exhausted directly to the atmosphere and vapours from the venting ports 174C, 174D may be subjected to further processing.

For example, venting ports 174A, 174B may primarily discharge water vapour and substances with boiling temperature below 100° C., and venting ports 174C, 174D may primarily discharge hydrocarbon vapours and substances with boiling temperatures above 150° C. or 200° C.

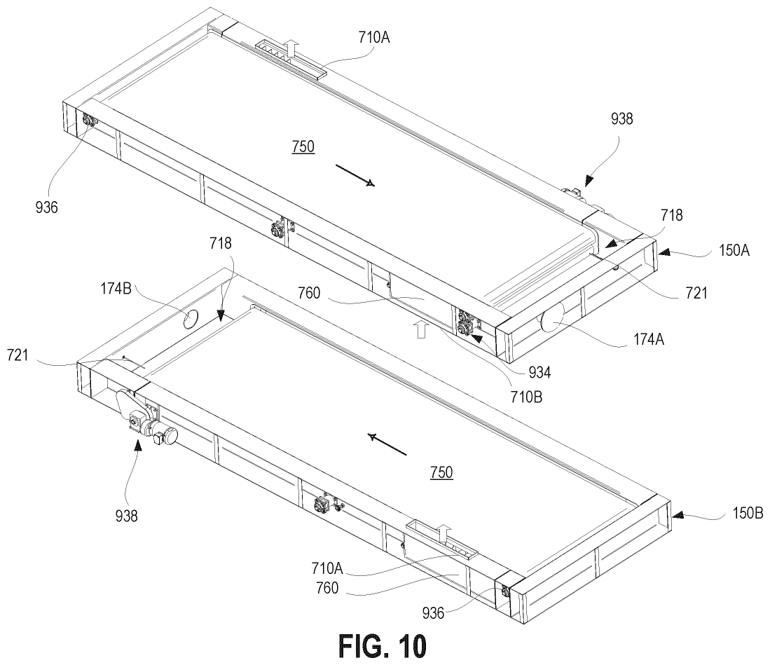

FIG. 12 is a schematic view of the duct 1200, in accordance with an embodiment, wherein the overlapping duct portions are shown adjacent to each other.

The duct 1200 is configured to carry fluid fluidly isolated from the material. The duct 1200 (or plenum) may be (hermetically) sealed to prevent outside air from entering the dryer 100 and also hot fluid from escaping out of the dryer 100, except in a controller manner via the fluid inlet 120 and fluid outlet 122.

The sequential arrangement of duct portions 410, 820 may form the substantially continuous duct 1200. The duct 1200 may extend underneath and above the zigzagging material path 1120 to form a zigzagging flow path 1220 (shown schematically in FIG. 12) adjacent thereto to transfer heat to the material from above and below/under. Zigzagging paths may include paths that alternate directions or overlap (across and over) themselves. The zigzagging flow path 1220 may extend across multiple vanes, including across lateral width(s) of the module(s), and may include a plurality of separate flow paths.

For each of module 150A, 150B, 150C, 150D, the duct extends from first side (underneath) the belt conveyer 750 to a second side opposed (above) the first side by wrapping around outer edges of the plurality of modules 150 and extending vertically between the first and second sides. These vertical sides may heat the material and may be staggered from one module to the next. For example, a heated vertical side of a belt conveyer may be opposed to a heated vertical side of a preceding and/or following belt conveyer.

The duct portion 1202A may be vertically aligned and disposed at an outer edge of the feeder 140 and the module 150A. The duct portion 1202B may be vertically aligned and disposed at an outer edge of the module 150A and 150B. In some embodiments, the duct portion 1202 may not include vanes and/or other obstructions.

The module 150C may be disposed in the section 1204. Additional modules may be disposed in the section 1204.

The zigzagging flow path 1220 may be adjacent to and fluidly isolated from the material path 1120 to heat the material sequentially from opposed sides lateral to the material path 1120 without contact, via barriers isolating the hot fluid from the material.

The material may be heated by conduction and radiation, e.g. infra-red radiation, from the heated outer surfaces of the duct 1200. In some embodiments, ambient air may be heated by conduction, which may then heat the material by (free) convection along the vertical height between adjacent modules.

The plurality of vanes 464, 964 (left off FIG. 12 for clarity) in the duct 1200 may be configured to distribute the hot fluid in the duct laterally across the plurality of belt conveyers, e.g. to cause substantially uniform heating of the material. The plurality of channels defined by the plurality of vanes 464, 964 may be arranged adjacent to one another and may be configured to distribute hot fluid (lateral to or) across the width of the duct 1200, so that heat is transferred substantially uniformly to the material of the belt conveyers from both sides, above and below.

Intermediate portions of the channels may be substantially straight and/or parallel to the direction of movement of the material of the belt conveyer. End portions of the channels may be oriented lateral to the intermediate portions. The plurality of vanes 464, 964 may be configured to orient the flow of the hot fluid parallel to the material as the material is moved or conveyed along the conveyer.

The temperature of the hot fluid may decrease from one duct to the next duct, as heat is transferred to the material. The temperature of the dryer 100 may vary accordingly. In some embodiments, a thermal expansion of the dryer 100 components may lead to varying sizes of slots, fasteners, and other components. In some embodiments, the dryer 100 may be configured for a specific range of temperature drop between the module feeder 140 and the module 150D.

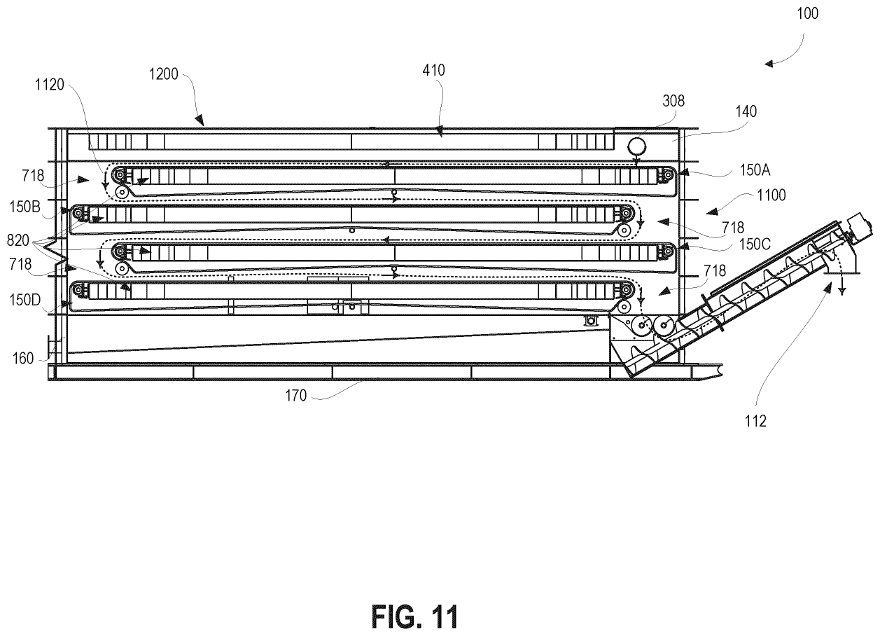

FIG. 13 is a partial schematic vane arrangement in a duct, in accordance with another embodiment.

The vanes may be arranged to yield 5 channels per module. In some embodiments, one or more of the modules may have more than 5 channels while others may have 5 or fewer channels.

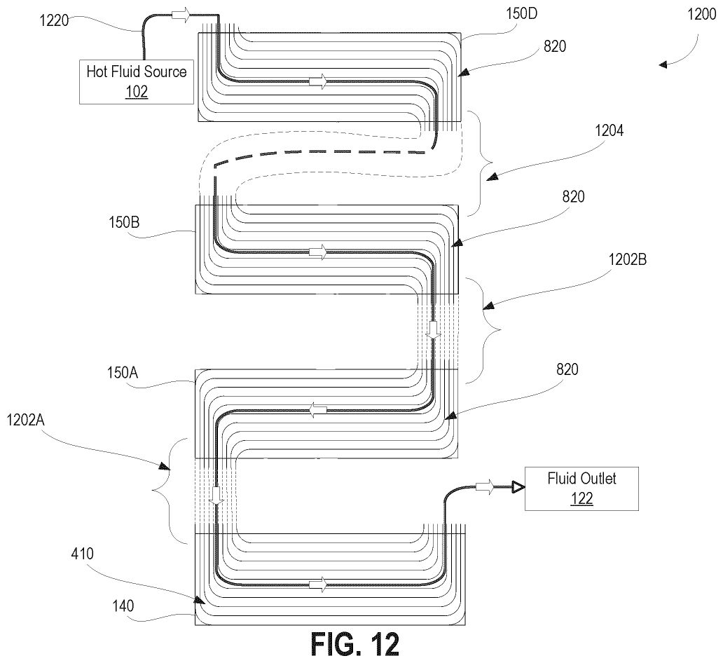

FIG. 14 is a schematic cross-sectional view of a grain dryer, as described in U.S. Pat. No. 4,253,825 to Fasano.

The grain dryer comprises a plurality of wire mesh (porous) horizontal conveyor belts through which hot air passes to dry the grain by contact therewith. The horizontal conveyer belts are arranged one above another in staggered relationship so that grain delivered to one end of the upper conveyor belt drops onto the lower conveyor belt when it gets to the other end of the upper conveyor belt and will then travel along the lower conveyor belt in opposite direction before being discharged. The hot air is then extracted through discharge conduits.

Drying sludge by contact therewith may lead to combustion and generation of toxic, harmful fumes. In some cases, hot air may not penetrate the sludge.

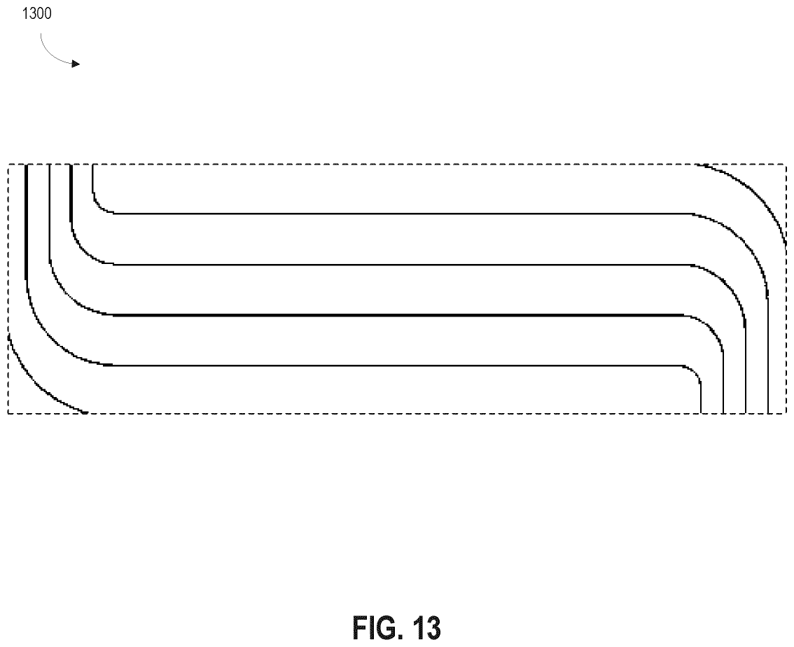

FIG. 15 is a side elevation view of an apparatus for drying fruit pulp, as described in U.S. Pat. No. 4,631,837 to Magoon.

The apparatus floats an infrared-transparent film (e.g. Mylar) on the surface of a body of heated water and places the fruit pulp and juice on top of the film to absorb heat from the water and thereby cause drying of the material. The apparatus for carrying out the method includes a reservoir of water, a film floated on the water, and a heater for maintaining the temperature of the water at a predetermined level. In a preferred embodiment, the reservoir is in the form of an elongated trough and the film comprises an endless strip of polyester material to form a conveyor belt that floats on the surface of the water in the trough and carries the material to be dried on it.

The drying may be limited by the boiling temperature of water. An uneven drying may result, due to drying only on one side of the material. Drying may be increased by lengthening the trough but this space constraints may prevent sufficient scalability. Using water for heating may inadvertently increase hydration, or lower drying rate, of the material due to humidity generated by evaporating water.

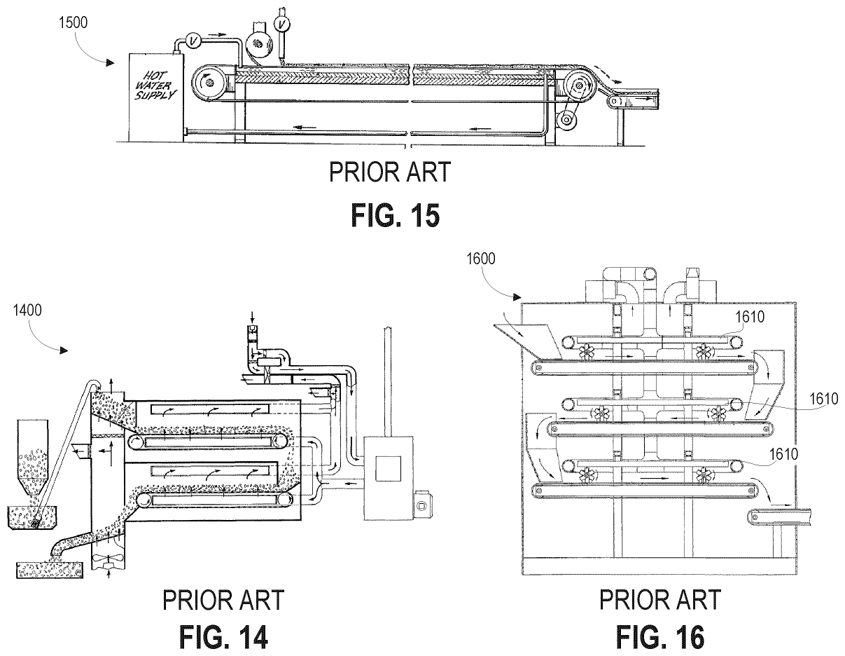

FIG. 16 is a schematic cross-sectional view of an infrared wood product dryer apparatus, as described in U.S. Pat. No. 5,557,858 to Macaluso et al.

The infrared wood product dryer apparatus includes a conveyor assembly configured for conveying a particulate cellulosic material, a gas recirculation to direct heated gas onto the material in order to convection-dry the cellulosic material, and an array of infrared radiant energy sources 1610 for exposing the cellulosic material to infrared radiant energy close to the absorption spectrum of water while the cellulosic material is conveyed along the path, and a series of agitators configured for agitating the cellulosic material in order to increase the exposure of the cellulosic material to the infrared radiant energy. Arrays of IR sources 1610 in this case are flameless catalytic gas fired infrared heaters and are positioned above belts as a means of exposing the material to IR radiant energy during the conveying of the cellulosic material along the flow path.

Agitation may be necessary as infrared heating is only provided from one-side and because the infrared resources may be placed relatively far from the wood product. The infrared heating may not be provided everywhere, e.g. sections of the belt conveyers may not be in proximity to infrared heating. Flameless catalytic gas fired infrared heaters may relatively costly. In practice, the number of such heaters deployed or deployable may be limited, e.g. due to cost and the overhead associated with each heating level. Convection drying may lead to other problems noted previously.

Dryers shown in FIGS. 14-16 are not easily scalable (modular), may result in toxic fumes, combustion of material, uneven drying, and may be relatively cost and energy inefficient.

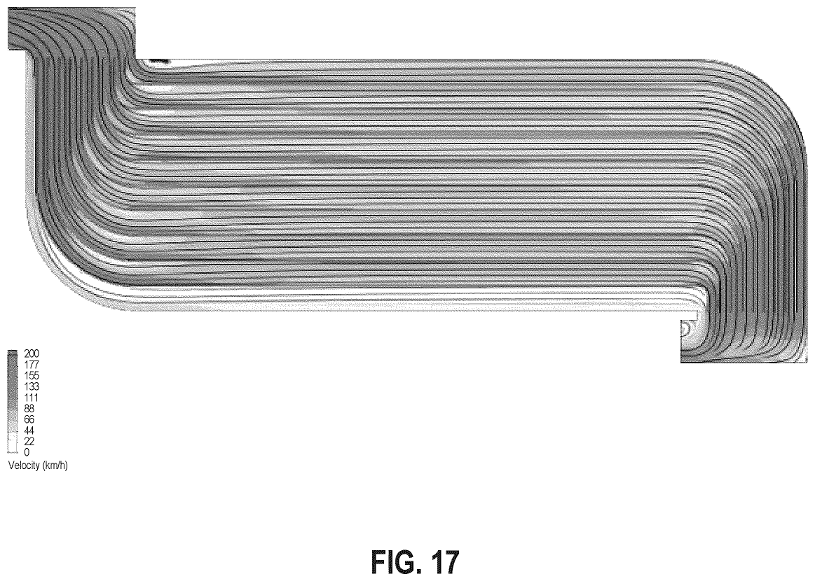

FIGS. 17-24 are computational results showing velocities and temperatures for example dryers (such as dryer 100). The computational results show contours in approximate gray scale.

FIG. 17 shows contours of velocity streamlines in an example module, in accordance with an embodiment.

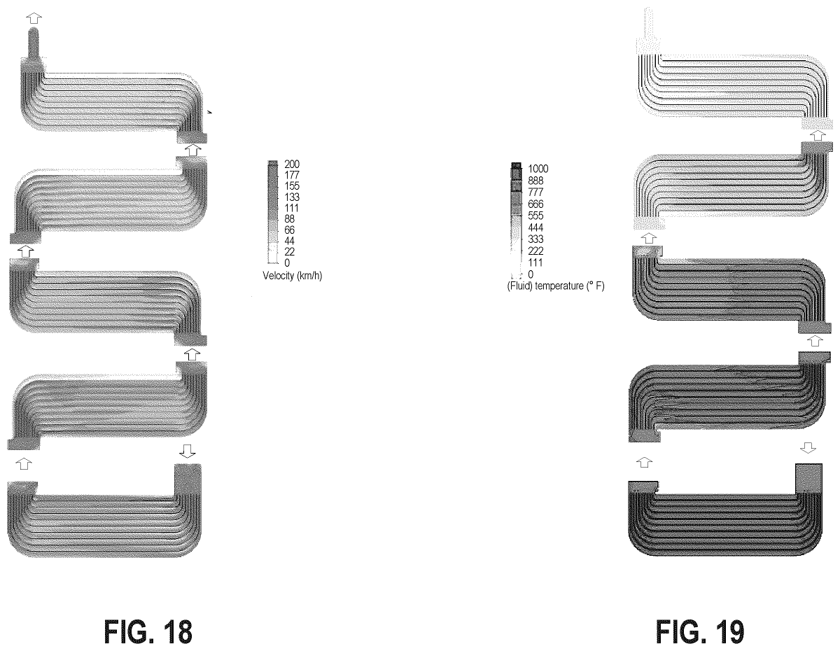

FIG. 18 shows contours of velocity, in accordance with the embodiment of FIG. 17.

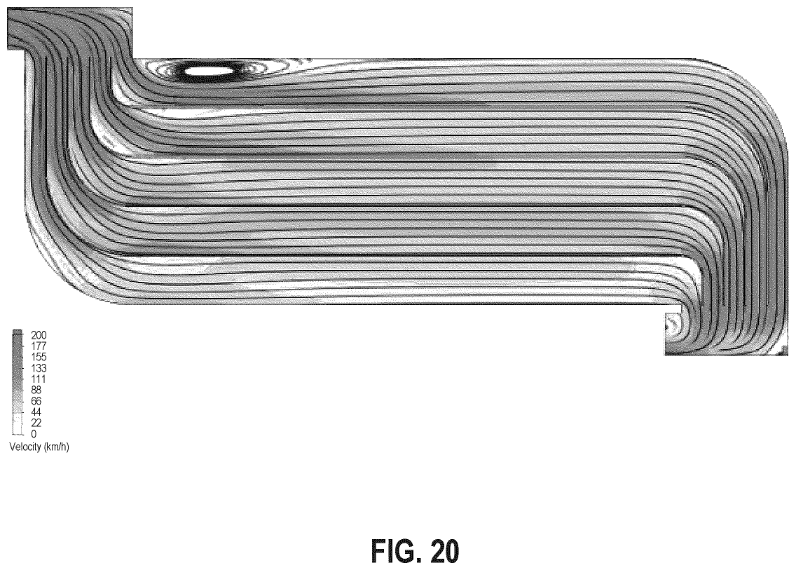

FIG. 19 shows contours of temperature, in accordance with the embodiment of FIG. 17.

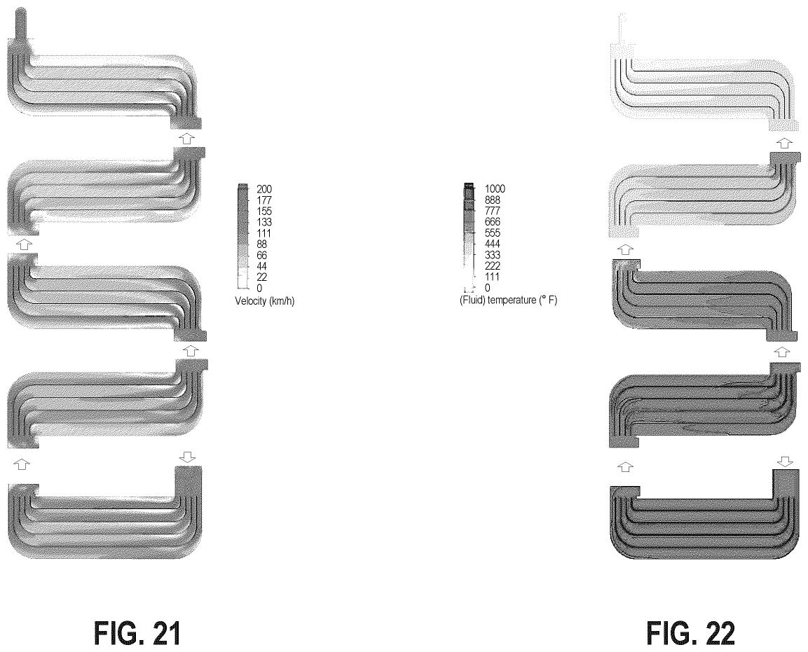

FIG. 20 shows contours of velocity streamlines in an example module, in accordance with another embodiment (see FIG. 13).

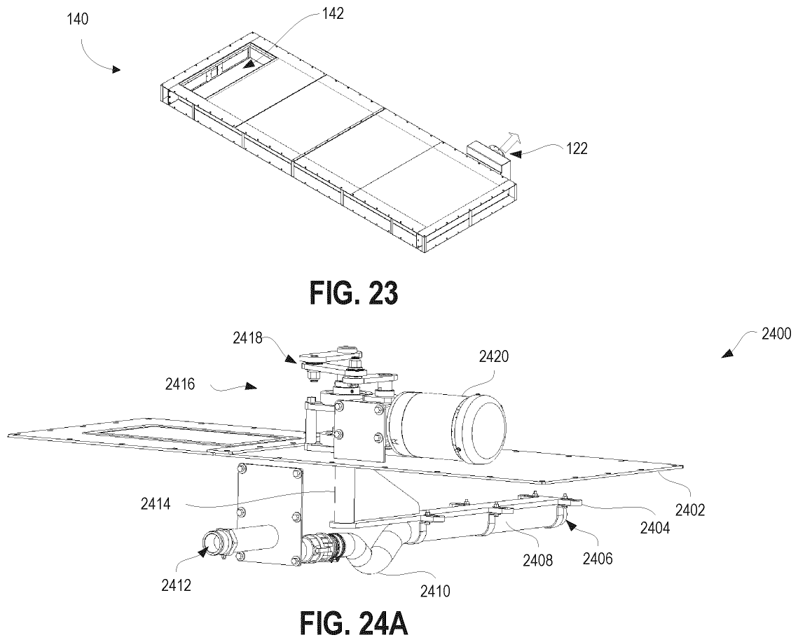

FIG. 21 shows contours of velocity, in accordance with the embodiment of FIG. 20.

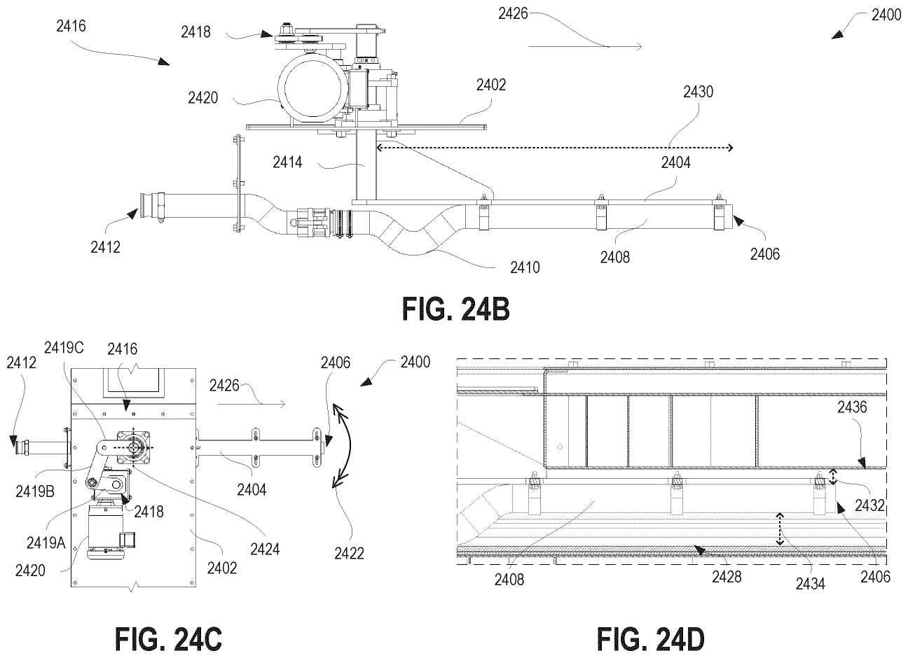

FIG. 22 shows contours of temperature, in accordance with the embodiment of FIG. 20.

In some embodiments, velocities in the duct may reach 200 km/h, temperature of the hot fluid may vary between 100° F. and 1000° F. from the inlet to the outlet of the dryer 100.

In some embodiments, turbulence may be generated inside the duct. For example, in some cases the duct may be adapted to prevent recirculation zones in the duct. In some embodiments, fluid static pressure at the inlet of dryer 100 may be 16-17 psi. In some embodiments, the measured pressure loss may be 2 psi.

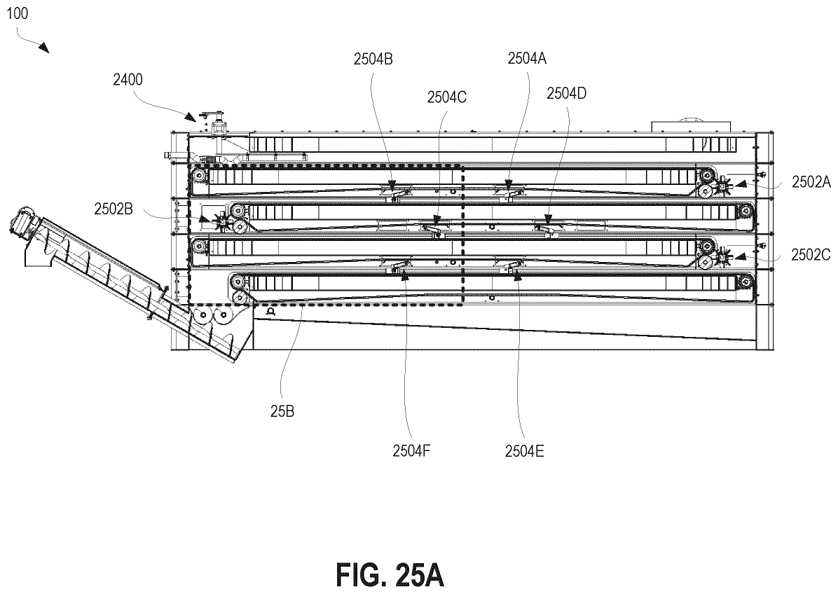

FIG. 23 is a perspective view of a feeder 140 of the dryer 100, showing the top of the feeder 140, in accordance with another embodiment.

The feeder 140 may not have a feed tube 308 (e.g. a built-in feed tube), as in the embodiment of FIG. 3A. In place of the feed tube 308, the feeder 140 may have a receptacle 142 configured to receive a feed device (or feed cartridge). The receptacle 142 may allow using the same dryer 100 for drying different materials, e.g. material with different flow properties and/or materials that are supplied to the dryer 100 at differing flow conditions.

In some embodiments, the feed tube 308 may be used for slurries or sludges that have a greater concentration of liquid and/or do not have large solids therein.

In some embodiments, the receptacle 142 may be defined by an opening. The opening may have a lip along its perimeter such that an opening from the top of the feeder 140 may be different (or differently sized) that an opening from the bottom of the feeder 140. The lip may be configured to support the feed device or cartridge. In various embodiments, the feed device or cartridge may be additionally fastened to the feeder 140 and/or dryer 100 using fasteners.

In some embodiments, a feed device may include the feed tube 308 fixedly attached to one side of a plate, e.g. a planar side of the plate. The plate may have a size adapted to dimensions of opening(s) defining the receptacle 142. At least two sides of the plate may be larger than corresponding sides of an opening from the bottom of the feeder 140 and smaller than corresponding sides of an opening from the top of the feeder 140 to allow a lip of the receptacle 142 to support the plate in the receptacle 142. In some embodiments, the lip may prevent the receptacle 142 from falling vertically through opening(s) of the receptacle 142.

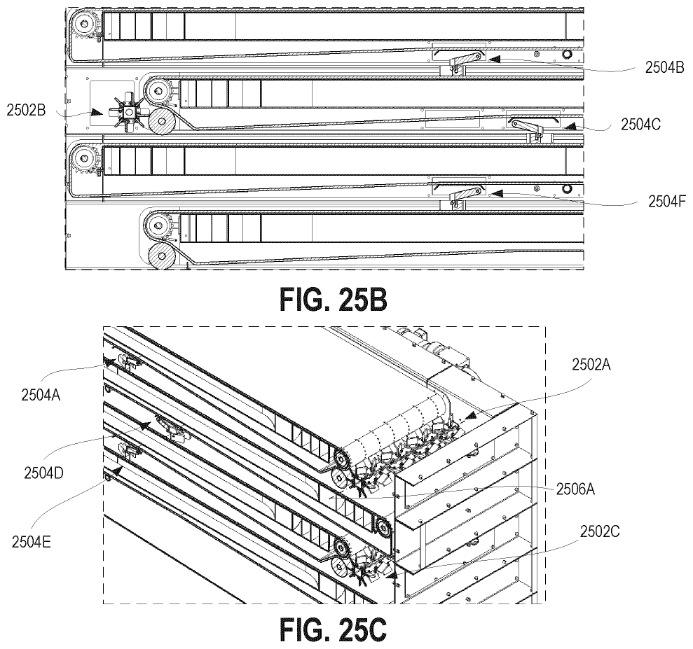

FIG. 24A is a perspective view of a feed device 2400, in accordance with an embodiment.

FIG. 24B is a side elevation view of the feed device 2400 of FIG. 24A.

FIG. 24C is a top plan view of the feed device 2400 of FIG. 24A.

FIG. 24D is a cross-sectional view of the dryer 100 with the feed device 2400 of FIG. 24A mounted therein.

The feed device 2400 may include, or in some cases, generally refer to an apparatus for feeding a conveyer, such as a conveyer made up of one or more belt conveyers configured to convey material in a longitudinal direction of the conveyer. In some cases, the direction 2426 may be parallel to the longitudinal direction of the conveyer. In some embodiments, the feed device 2400 may include components for providing attachment, positioning, and other functions to the apparatus. For example, such components may allow attachment to the feeder 140.

The feed device 2400 may be configured to be received in the receptacle 142 of the feeder 140 and to be mounted in the dryer 100 via the feeder 140.

The feed device 2400 may include a plate 2402 (or other coupling component) complementary to the receptacle 142. The plate 2402 may dimensioned based on the receptacle 142.

A conduit 2408 of the feed device 2400 may be configured to receive material via a conduit inlet 2412 (or inlet of the conduit) to supply the material to the conveyer via a conduit outlet 2406 (or outlet of the conduit). The conduit 2408 may be tubular shaped and/or may have a cross-sectional area normal to the flow (or diameter) adapted to properties of the fluid, e.g. rheological properties. For example, certain materials may have solid particles or aggregations formed therein. For such materials, a larger cross-sectional area may provide improved flow through the conduit.

The conduit 2408 may extend over a conveying surface 2428 of the conveyer between a pivot 2414 and the conduit outlet 2406. In some embodiments, the conveying surface 2428 may be a surface of a belt of a belt conveyer. In various embodiments, the conveying surface 2428 may be planar. The pivot 2414 and the conduit outlet 2406 may be separated in the longitudinal direction by a separation 2430. In some embodiments, the conduit 2408 may have one or more bends, such as the bend 2410.

In various embodiments, the conduit 2408 may extend parallel to the conveying surface 2428 between the pivot 2414 and the conduit outlet 2406.

In some embodiments, the conduit outlet 2406 may open non-parallel to the conveying surface 2428. In some embodiments, the conduit outlet 2406 may open perpendicular to the conveying surface 2428.

In some embodiments, the pivot 2414 and the conduit outlet 2406 may be predominantly separated in the longitudinal direction, e.g. a vector defining the spatial separation of the pivot 2414 from the conduit outlet 2406 may have its component in the longitudinal direction being the largest vector component or larger than any single vector component aligned in any direction normal to the longitudinal direction. In some embodiments, the pivot 2414 and the conduit outlet 2406 may be separated only in the longitudinal direction.

The pivot 2414 may refer to a location or component for pivoting and may define an axis 2424 for rotation of the conduit 2408 thereabout.

In some embodiments, the conduit 2408 may be elongated in the longitudinal direction over the conveying surface 2428 of the conveyer between the pivot 2414 and the conduit outlet 2406. In some embodiments, the conduit 2408 may be considered to be elongated in the longitudinal direction if it is elongated predominantly in the longitudinal direction.

The conduit 2408 may be coupled for rotation about the pivot 2414. In some embodiments, the conduit 2408 may be coupled to the pivot 2414 via a coupler 2404. In various embodiments, the coupler 2404 may be or may include a plate attached to an external portion of the conduit 2408. Such may be connected to a pin defining the pivot 2414 to allow common rotation of the pin and the conduit 2408.

The feed device 2400 may have a driver 2416 coupled to the conduit 2408 to rotate the conduit 2408 about the pivot 2414 to move the conduit outlet 2406 at least partially laterally over the conveying surface 2428 to spread the material on the conveying surface 2428. In some embodiment, effective spreading of the material may be achieved by the feed device 2400 in a compact space.

In some embodiments, the driver 2416 may include a three-bar linkage 2418 including bars 2419A, 2419B, 2419C. The driver 2416 may be configured to rotate the conduit 2408 about an axis 2424 normal to the conveying surface 2428. In some embodiments, the axis 2424 may be non-perpendicular to the conveying surface 2428 but may be predominantly normal thereto. In some embodiments, the pivot 2414 may be stationary when the conduit 2408 is rotated about the axis 2424 and/or the pivot 2414. In some embodiments, the conduit 2408 may be substantially parallel to the conveying surface 2428 during rotation of the conduit 2408.

Under non-reciprocating rotation of the bar 2419A, the three-bar linkage 2418 may be configured to cause reciprocating rotation of the conduit 2408 via reciprocating rotation of the bar 2419C about the axis 2424. The bar 2419A may rotate without reversing its rotational direction (non-reciprocating). Under such rotation of the bar 2419A, the bar 2419C may periodically reverse its direction of rotation (angular velocity) to cause a wagging motion of the conduit outlet 2406, as indicated by the double-headed arrow 2422. In some embodiments, under such non-reciprocating rotation, the conduit outlet 2406 may circumscribe a circular arc defined between two opposed arc points and associated with a circular radius defined by the separation 2430. A motor 2420, such as a permanent magnet motor, may be used to rotatably drive the bar 2419A.

In various embodiments, the longitudinal separation 2430 between the pivot 2414 and the conduit outlet 2406 may be configured to laterally spread the material on the conveying surface 2428 between lateral ends of the conveying surface 2428. For example, lateral ends may be defined with respect to or based on a width 712 of a belt conveyer 750. The lateral ends may define a region whereon it is desired to spread the material. The longitudinal separation 2430 may define a moment arm about the pivot 2414 for force exerted at the conduit outlet 2406.

The conduit 2408 may be spaced apart from the conveying surface 2428 by a spacing 2434 and spaced apart from a surface 2436 opposed the conveying surface 2428 by a spacing 2432. In various embodiments, the spacing 2432 may smaller than the spacing 2434. In some embodiments, the spacing 2432 may half or less than half of the spacing 2434.

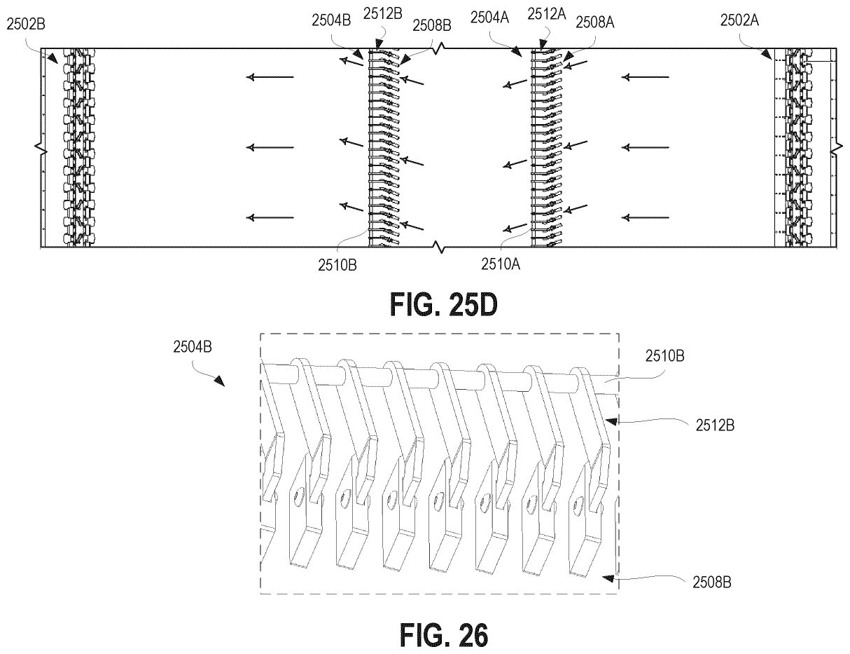

FIG. 25A is a partial cross-sectional view of a dryer 100, in accordance with another embodiment.

The embodiment of the dryer 100 shown in FIG. 25A to the embodiment shown in FIG. 11, in some respects. It is understood that reference numerals and material path(s) shown in FIG. 11 may be adapted to FIG. 25A, mutatis mutandis.

FIG. 25B is an enlarged view of region 25B in FIG. 25A.

FIG. 25C is a perspective view of the dryer 100 of FIG. 25A, with a feeder of the dryer 100 not shown mounted on the dryer 100.

FIG. 25D is a top plan view of the dryer 100 of FIG. 25A, with the feeder and an upper module of the dryer 100 not shown mounted on the dryer 100. Example material flow is depicted in FIG. 25D using hollow-headed arrows.

The dryer 100 may comprise a plurality of agitators 2502A-2502C. The material may flow sequentially through agitator 2502A, agitator 2502B, and then agitator 2502C.

Agitation surfaces of the agitator 2502A may be planar shaped, arcuately shaped, or have other shapes adapted to break-up, and/or mix the material moving past the agitation surface without introducing excessive friction.

The agitator 2502A may be a paddle agitator. The agitator 2502A may include a plurality of paddles distributed around a central axis of rotation. The agitator 2502A may be disposed at the end of a belt conveyer 750 or another conveyer. The agitator 2502A may be positioned such that the material falls into the agitator 2502A during operation of the agitator 2502A. The agitator 2502A may be positioned to receive the material as the material falls between vertically adjacent belt conveyers to cause break up and stirring of the material.

In various embodiments, the agitator 2502A may be actively driven by a motor as the material is driven by the material falling through the agitator 2502A. In some embodiments, it may be advantageous to use a variable-frequency drive (VFD) motor to drive the agitator 2502A. In some embodiments, the agitator 2502A may be positioned between vertically adjacent belt conveyers 750 such that the material passes through the agitator 2502A as it moves from one belt conveyer 750 to the other belt conveyer 750. It is understood that agitators 2502B and 2502C may be similarly constructed.

In various embodiments, a rotational velocity and/or torque associated with the agitator 2502A may be adapted for achieving drying of the material. For example, the rotational velocity and/or torque may be increased to achieve greater homogeneity in drying of the material. In some embodiments, the rotational velocity and/or the torque may be controlled via the controller 190. For example, a motor driving the agitator 2502A may be coupled to the controller 190 to agitate the material.

The dryer 100 may also comprise a plurality of vane assemblies 2504A-2504F positioned in the material path. In some embodiments, each belt conveyer may have disposed thereon at least two vane assemblies. These two vane assemblies may be separated from each other.

The material may flow through the vane assembly 2504A, the vane assembly 2504B, the vane assembly 2504C, the vane assembly 2504D, the vane assembly 2504E, and then the vane assembly 2504F.

FIG. 26 is a perspective view of the vane assembly 2504B, in accordance with an embodiment.

The vane assembly 2504B may comprise a plurality of vanes 2508B coupled to a shaft 2510B via a plurality of support brackets 2512B. Similarly, the vane assembly 2504A may comprise a plurality of vanes 2508A coupled to a shaft 2510A via a plurality of support brackets 2512A.

It is understood that, in some embodiments, each of the plurality of vane assemblies 2504A-2504F may be of similar construction, in some respects.

The plurality of vanes 2508B may each be substantially planar. The plurality of vanes 2508B may be positioned in the material path on the conveyer (as shown by arrows depicting example material flow in FIG. 25D) such that the material is partially obstructed by the plurality of vanes 2508B. The plurality of vanes 2508A may be similarly positioned.

The plurality of vanes 2508A may be inclined between 0° and 90° to the material flow in a plane containing the conveying surface, while the plurality of vanes 2508B may be inclined between 0 and −90°. The plurality of vanes 2508A and the plurality of vanes 2508B may be adjacent vanes inclined in opposing directions to encourage break up and mixing of the material. For example, a hard upper crust formed on the material upon drying may be broken up by the plurality of vanes 2508A, 2508B.

The plurality of support brackets 2512B may be individually rotatable about the shaft 2510B to allow the plurality of vanes 2508B to rise and fall vertically in response to flow of the material being obstructed by the plurality of vanes 2508B (floating vanes). A floating configuration may allow the vane assembly 2504B to adapt to changes in shape of the system, e.g. warping or expansion due to thermal variations.

In some embodiments, the plurality of vanes 2508B may be constructed of low friction and/or low wear material. In some embodiments, in regions of the dryer 100 exposed to temperatures below 400° C., vanes may be constructed of ultra high molecular weight (UHMW) polymer(s). In some embodiments, in regions of the dryer 100 exposed to temperatures above 400° C. (e.g. 600° C.), vanes may be constructed of teflon.

In various embodiments, the vane assemblies 2504A-2504F may be configured to work together (complementarily) with the agitators 2502A-2502C.

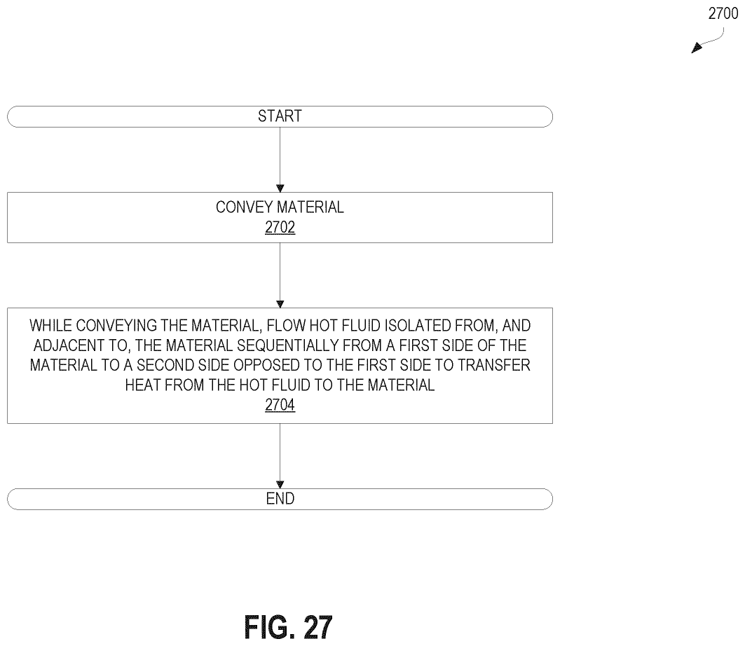

FIG. 27 is a flow chart of a method 2700 of drying material, in accordance with an embodiment.

At step 2702, the method 2700 may include conveying the material.

At step 2704, the method 2700 may include flowing hot fluid isolated from, and adjacent to, the material sequentially from a first side of the material to a second side opposed to the first side to transfer heat from the hot fluid to the material.

In some embodiments of the method 2700, the material may be conveyed along a first material path.

Some embodiments of the method 2700 may include conveying the material along a second material path above the first material path; and while conveying the first material over the first and second material paths, flowing the hot fluid sequentially underneath the first material path and between the first material path and the second material path to heat the material being conveyed along the first material path from at least above and below and to heat the material being conveyed along the second material path from at least below.

Some embodiments of the method 2700 may include reheating the hot fluid after the flowing of the hot fluid isolated from, and adjacent to, the material sequentially from the first side of the material to the second side opposed to the first side.

Some embodiments of the method 2700 may include flowing hot fluid isolated from, and adjacent to, the material sequentially from the first side of the material to the second side opposed to the first side after the reheating of the hot fluid.

Some embodiments of the method 2700 may include controlling a mass flow rate of the hot fluid flowing isolated from, and adjacent to, the material based on a temperature, after transferring heat from the hot fluid to the material, of at least one of the hot fluid or the material.

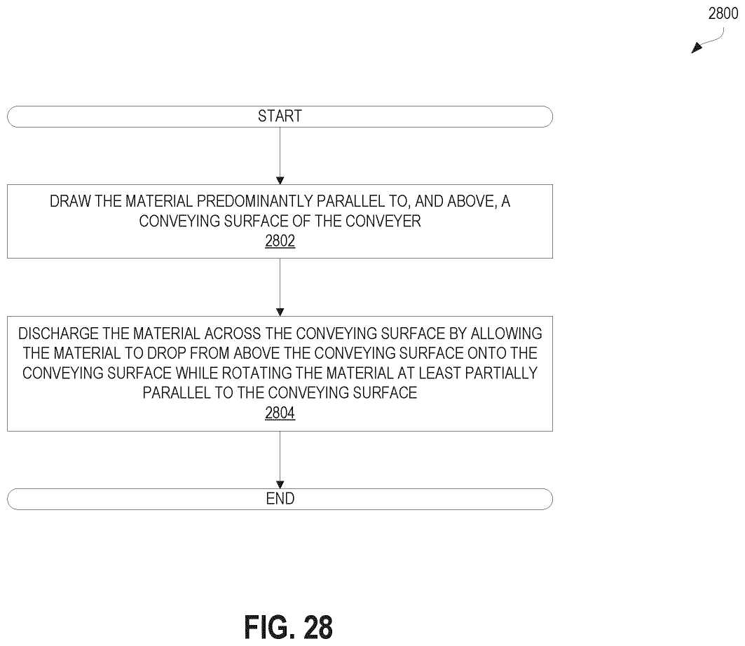

FIG. 28 is a flow chart of a method 2800 of feeding a conveyer configured to convey material in a longitudinal direction, in accordance with an embodiment.

At step 2802, the method 2800 may include drawing the material predominantly parallel to, and above, a conveying surface of the conveyer.

Drawing the material predominantly parallel to the conveying surface may refer to drawing the material in an overall direction that is parallel to the conveying surface. Material may be drawn from a first end over the conveying surface till a second end.

For example, the material may be drawn in a zigzagging conduit having two ends that define a line therebetween predominantly parallel to the conveying surface. Such a line may have the largest vector component that is parallel to the conveying surface.

At step 2804, the method 2800 may include discharging the material across the conveying surface by allowing the material to drop from above the conveying surface onto the conveying surface while rotating the material at least partially parallel to the conveying surface.

In some embodiments of the method 2800, drawing the material predominantly parallel to, and above, a conveying surface of the conveyer may include drawing the material through a conduit disposed above and spaced apart from the conveying surface.

In some embodiments of the method 2800, the conveying surface may be planar.

In some embodiments of the method 2800, the material may be discharged in a discharge region of the conveying surface and rotating the material at least partially parallel to the conveying surface may include rotating the material about a pivot longitudinally separated from the discharge region.

In some embodiments of the method 2800, the pivot may be normal to the conveying surface.

In some embodiments of the method 2800, drawing the material predominantly parallel to, and above, a conveying surface of the conveyer may include preventing movement of the material non-parallel to the conveying surface.

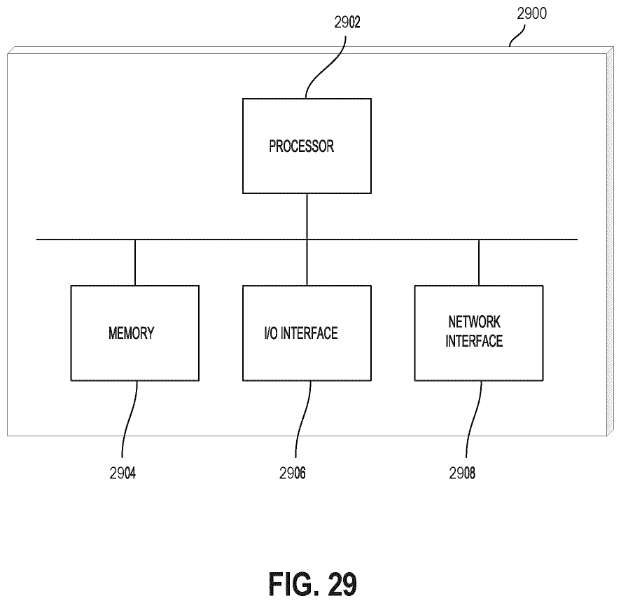

FIG. 29 illustrates a block diagram of a computing device 2900, in accordance with an embodiment.

As an example, the controller 1900 of FIG. 1 may be implemented using the example computing device 1000 of FIG. 29.

The computing device 2900 includes at least one processor 2902, memory 2904, at least one I/O interface 2906, and at least one network communication interface 2908.

The processor 2902 may be a microprocessor or microcontroller, a digital signal processing (DSP) processor, an integrated circuit, programmable logic controller (PLC), a field programmable gate array (FPGA), a reconfigurable processor, a programmable read-only memory (PROM), or combinations thereof.

The memory 2904 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

The I/O interface 2906 may enable the computing device 2900 to interconnect with one or more input devices, such as a keyboard, mouse, camera, touch screen and a microphone, or with one or more output devices such as a display screen and a speaker.

The networking interface 2908 may be configured to receive and transmit data sets representative of the machine learning models, for example, to a target data storage or data structures. The target data storage or data structure may, in some embodiments, reside on a computing device or system such as a mobile device.

In various embodiments, the controller 1900 (e.g. via PLC programming) may be configured to maintain desired or target conditions in the entire system, including mass flow rate, velocity, and temperature of each of the material being dried and the fluid being used to transfer the heat energy for drying. For example, the fan 111 may be configured to function to maintain a desired or target pressure at inlet 120 and/or outlet 122. In some embodiments, such target pressure may be measured in negative ‘Inches of Water Column’, as it may be a low pressure system. In various embodiments, the mixing valve 105, venting valve 107, and duct heaters may be manipulated to achieve a mixture quality and mass of recirculated and reheated fluid, and cooled and exhausted fluid to achieve a desired or target mass flow rate and/or temperature of hot fluid through the dryer 100.

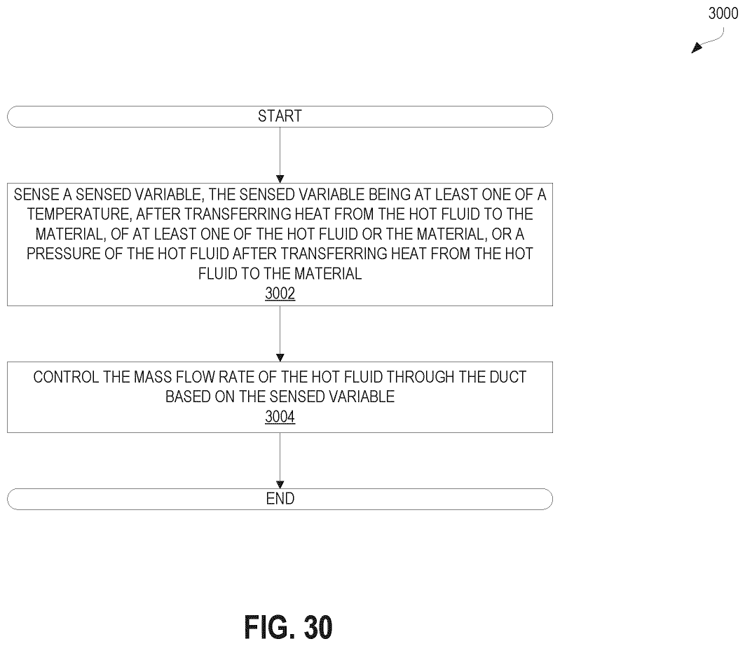

FIG. 30 is a flow chart of a computer-implemented method 3000 of controlling the dryer 100.

At step 3002, the method 3000 may include sensing a sensed variable, the sensed variable being at least one of a temperature, after transferring heat from the hot fluid to the material, of at least one of the hot fluid or the material, or a pressure of the hot fluid after transferring heat from the hot fluid to the material.

At step 3004, the method 3000 may include controlling the mass flow rate of the hot fluid through the duct based on the sensed variable.

In some embodiments, the method 3000 may include controlling the pressure, or at least one of the pressure or the mass flow rate, of the hot fluid through the duct based on the sensed variable.

As can be understood, the examples described above and illustrated are intended to be exemplary only.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, hot fluid in the dryer may flow in the same direction as the material (co-flow), a material outlet may be disposed adjacent to the last module without the discharge conveyer, the material may be brought into the dryer without the use of a feed tube, hot fluid exiting the dryer may not be recirculated, and/or dryer may be placed sideways or in other geometrical configurations wherein gravity may not be used, or only partially used, to aid in transport of material (geometrical features may be adapted accordingly). Yet further modifications could be implemented by a person of ordinary skill in the art in view of the present disclosure, which modifications would be within the scope of the present technology.

The term “connected” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

What is claimed is:

1. A dryer for drying material, comprising:
a conveyer for conveying the material between an inlet and an outlet of the dryer; and
a duct for carrying hot fluid fluidly isolated from the material, the duct extending adjacent to the conveyer from a first side of the conveyer to a second side of the conveyer opposed to the first side to heat the material from the first side and the second side by transferring heat from the hot fluid.

2. The dryer of claim 1, wherein
the conveyer includes
a plurality of belt conveyers extending partially over each other to sequentially convey the material; and
the duct extends underneath each belt conveyer of the plurality of belt conveyers to heat the material from under and above, the duct including
a plurality of vanes configured to distribute the hot fluid laterally in the duct, relative to a direction of flow of the hot fluid in the duct, to heat the material across the plurality of belt conveyers.

3. The dryer of claim 2, further comprising:
an agitator positioned to receive the material as the material falls between vertically adjacent belt conveyers of the plurality of belt conveyers.

4. The dryer of claim 3, wherein the agitator is driven by a motor coupled to a controller to agitate the material.

5. The dryer of claim 3, wherein the agitator includes a plurality of paddles distributed around a central axis of rotation.

6. The dryer of claim 1, wherein the duct includes a plurality of vanes configured to distribute the hot fluid laterally in the duct, relative to a direction of flow of the hot fluid in the duct, to heat the material substantially uniformly across the conveyer.

7. The dryer of claim 6, wherein the plurality of vanes are configured to orient the flow of the hot fluid parallel to the material as the material is moved by the conveyer.

8. The dryer of claim 1, further comprising:
a plurality of vanes positioned in a material path to partially obstruct the material as it moves on the conveyer.

9. The dryer of claim 8, wherein the plurality of vanes are configured to rise and fall vertically in response to flow of the material being obstructed by the plurality of vanes.

10. The dryer of claim 1, wherein the conveyer defines a conveying surface that is planar, and the duct has planar portions adjacent to the conveying surface.

11. The dryer of claim 1, wherein the conveyer is configured to convey the material in a longitudinal direction when receiving the material via the inlet of the dryer, the dryer further comprising:
a conduit configured to receive the material from the inlet of the dryer to supply the material to the conveyer via an outlet of the conduit, the conduit extending over a conveying surface of the conveyer between a pivot and the outlet of the conduit, the pivot and the outlet of the conduit being separated in the longitudinal direction; and
a driver coupled to the conduit to rotate the conduit about the pivot to move the outlet of the conduit at least partially laterally over the conveying surface to spread the material on the conveying surface.

12. The dryer of claim 11, wherein the pivot and the outlet of the conduit are predominantly separated in the longitudinal direction.

13. The dryer of claim 1, further comprising:
a heater configured to heat fluid received from the duct to heat the fluid to generate the hot fluid for recirculation through the duct, the fluid being generated by cooling of the hot fluid.

14. The dryer of claim 1, wherein the hot fluid is a first hot fluid, the dryer further comprising:
a mixing valve configured to receive fluid from the duct to mix the fluid with a second hot fluid to generate the first hot fluid for recirculation through the duct, the fluid being generated by cooling of the first hot fluid.

15. The dryer of claim 1, further comprising:
a controller configured to control a mass flow rate of the hot fluid through the duct based on a temperature, after transferring heat from the hot fluid to the material, of at least one of the hot fluid or the material.

16. A method of drying material, comprising:
conveying the material; and
while conveying the material,
flowing hot fluid isolated from, and adjacent to, the material sequentially from a first side of the material to a second side opposed to the first side to transfer heat from the hot fluid to the material.

17. The method of claim 16, wherein the material is conveyed along a first material path, the method further comprising:
conveying the material along a second material path above the first material path; and
while conveying the first material over the first and second material paths,
flowing the hot fluid sequentially underneath the first material path and between the first material path and the second material path to heat the material being conveyed along the first material path from at least above and below and to heat the material being conveyed along the second material path from at least below.

18. The method of claim 16, further comprising:
reheating the hot fluid after the flowing of the hot fluid isolated from, and adjacent to, the material sequentially from the first side of the material to the second side opposed to the first side.

19. The method of claim 18, further comprising:
flowing hot fluid isolated from, and adjacent to, the material sequentially from the first side of the material to the second side opposed to the first side after the reheating of the hot fluid.

20. The method of claim 16, further comprising:
controlling a mass flow rate of the hot fluid flowing isolated from, and adjacent to, the material based on a temperature, after transferring heat from the hot fluid to the material, of at least one of the hot fluid or the material.

21. An apparatus for drying particulate moisture-bearing material, comprising:
a material inlet configured to receive a continuous stream of the material for drying;
a material outlet for discharging the material after drying;
a plurality of belt conveyers being vertically stacked and partially horizontally staggered to sequentially convey the material vertically and horizontally in a zigzag material path from the material inlet to the material outlet, including
an inlet belt conveyer for receiving the continuous stream of the material, the material being deposited substantially evenly along a width of the inlet belt conveyer;
a fluid inlet for receiving fluid from a hot fluid source;
a fluid outlet for discharging the fluid and fluidly connected to the fluid inlet; and
a duct for conveying fluid from the fluid inlet to the fluid outlet, the duct extending underneath the plurality of belt conveyers defining the zigzag material path to form a zigzag flow path to transfer heat to the material from above and below.

22. A module for a dryer, comprising:
a belt conveyer for conveying material to be dried; and
a duct portion disposed adjacent to the belt conveyer for conveying hot fluid fluidly isolated from the belt conveyer, the duct portion comprising one or more ports for interfacing with one or more other modules.

23. The module of claim 22, wherein the module includes a plurality of vanes configured to distribute the hot fluid laterally in the duct portion, relative to a direction of flow of the hot fluid in the duct portion, to heat the material being conveyed by the belt conveyer.

24. The module of claim 23, wherein the plurality of vanes are configured to orient the flow of the hot fluid parallel to the material as the material is moved by the belt conveyer.

25. A dryer for drying material, comprising a plurality of modules according to claim 23, the plurality of modules interfaced to form a plurality of belt conveyers conveying the material along a zigzagging material path and a plurality of duct portions sequentially connected to define a duct conveying hot fluid along a zigzagging flow path extending adjacent to and fluidly isolated from the material path to heat the material from opposed sides lateral to the material path.

26. An apparatus for feeding a conveyer configured to convey material in a longitudinal direction, comprising:
a conduit configured to receive material to supply the material to the conveyer via an outlet of the conduit, the conduit extending over a conveying surface of the conveyer between a pivot and the outlet of the conduit, the pivot and the outlet of the conduit being separated in the longitudinal direction; and
a driver coupled to the conduit to rotate the conduit about the pivot to move the outlet at least partially laterally over the conveying surface to spread the material on the conveying surface.

27. The apparatus of claim 26, wherein the pivot and the outlet of the conduit are predominantly separated in the longitudinal direction.

28. The apparatus of claim 26, wherein the pivot is stationary when the conduit is rotated about the pivot.

29. The apparatus of claim 26, wherein the conveyer is a belt conveyer, and the conveying surface is a surface of a belt of the belt conveyer.

30. The apparatus of claim 26, wherein the outlet opens non-parallel to the conveying surface.

31. The apparatus of claim 26, wherein the outlet opens perpendicular to the conveying surface.

32. The apparatus of claim 26, wherein the conduit extends parallel to the conveying surface between the pivot and the outlet.

33. The apparatus of claim 26, wherein the driver includes a three-bar linkage configured to cause reciprocating rotation of the conduit under non-reciprocating rotation of a bar of the three-bar linkage.

34. The apparatus of claim 26, wherein the driver is configured to rotate the conduit about an axis normal to the conveying surface.

35. The apparatus of claim 26, wherein the conduit is substantially parallel to the conveying surface during rotation of the conduit.

36. The apparatus of claim 26, wherein the conveying surface is planar.

37. The apparatus of claim 26, wherein the conduit is elongated in the longitudinal direction.

38. The apparatus of claim 26, wherein a longitudinal separation between the pivot and the outlet of the conduit is configured to laterally spread the material on the conveying surface between lateral ends of the conveying surface.

39. A method of feeding a conveyer configured to convey material in a longitudinal direction, comprising:
drawing the material predominantly parallel to, and above, a conveying surface of the conveyer; and
discharging the material across the conveying surface by allowing the material to drop from above the conveying surface onto the conveying surface while rotating the material at least partially parallel to the conveying surface.

40. The method of claim 39, wherein drawing the material predominantly parallel to, and above, a conveying surface of the conveyer includes drawing the material through a conduit disposed above and spaced apart from the conveying surface.

41. The method of claim 39, wherein the conveying surface is planar.

42. The method of claim 39, wherein the material is discharged in a discharge region of the conveying surface and rotating the material at least partially parallel to the conveying surface includes rotating the material about a pivot longitudinally separated from the discharge region.

43. The method of claim 42, wherein the pivot is normal to the conveying surface.

44. The method of claim 39, drawing the material predominantly parallel to, and above, a conveying surface of the conveyer includes preventing movement of the material non-parallel to the conveying surface.

45. A dryer for drying material, comprising:
a conveyer for conveying the material between an inlet and an outlet of the dryer, the conveyer configured to convey the material in a longitudinal direction when receiving the material via the inlet of the dryer;
a conduit configured to receive the material from the inlet of the dryer to supply the material to the conveyer via an outlet of the conduit, the conduit extending over a conveying surface of the conveyer between a pivot and the outlet of the conduit, the pivot and the outlet of the conduit being separated in the longitudinal direction; and
a driver coupled to the conduit to rotate the conduit about the pivot to move the outlet of the conduit at least partially laterally over the conveying surface to spread the material on the conveying surface.

46. The dryer of claim 45, wherein the pivot and the outlet of the conduit are predominantly separated in the longitudinal direction.

47. A computer-implemented method of controlling the dryer of any one of claims 1 to 14, the method comprising:
sensing a sensed variable, the sensed variable being at least one of a temperature, after transferring heat from the hot fluid to the material, of at least one of the hot fluid or the material, or a pressure of the hot fluid after transferring heat from the hot fluid to the material; and
controlling the mass flow rate of the hot fluid through the duct based on the sensed variable.

48. A system for controlling the dryer of any one of claims 1 to 14, the system comprising:
a processor;
computer-readable memory coupled to the processor and storing processor-executable instructions that, when executed, configure the processor to execute the computer-implemented method of claim 47.

49. A non-transitory computer-readable medium having stored thereon machine interpretable instructions which, when executed by a processor, cause the processor to perform the computer-implemented method of claim 47.

50. The dryer of any one of claims 1 to 14, wherein the hot fluid includes gases generated by a gasification system.
